(19) United States
(12) Patent Application Publication
(10) Pub. No.: US 2025/0019536 A1
(43) Pub. Date: Jan. 16, 2025

(54) STRESS REDUCING AGENT AND RESIN COMPOSITION

(71) Applicant: KANEKA CORPORATION, Osaka (JP)

(72) Inventor: Nobuyoshi Maizuru, Hyogo (JP)

(73) Assignee: KANEKA CORPORATION, Osaka (JP)

(21) Appl. No.: 18/898,099

(22) Filed: Sep. 26, 2024

Related U.S. Application Data
(63) Continuation of application No. PCT/JP2023/011771, filed on Mar. 24, 2023.

(30) Foreign Application Priority Data
Mar. 29, 2022 (JP) 2022-054290

(51) Int. Cl. C08L 63/00; C08K 3/36; C08K 7/16

(52) U.S. Cl. CPC C08L 63/00; C08K 3/36; C08K 7/16

(57) ABSTRACT

A stress reducing agent that is excellent in dispersibility in a matrix resin and enables provision of a cured product having a favorable linear expansion coefficient is provided. The stress reducing agent contains fine polymer particles (A). The particles (A) contain a rubber-containing graft copolymer including an elastic body and a graft part grafted to the elastic body. The elastic body contains an organosiloxane-based rubber. The elastic body is contained in an amount of above 70 wt % and 97 wt % or less, relative to 100 wt % of the particles (A). The graft part contains an epoxy group-containing structural unit. The epoxy group-containing structural unit in the graft part is contained in an amount of 0.5-4.0 wt % with respect to 100 wt % of the rubber-containing graft copolymer. The stress reducing agent is a powdery and/or granular material.

### TECHNICAL FIELD

One or more embodiments of the present invention relate to a stress reducing agent and a resin composition.

### BACKGROUND

As a sealing material mainly used in a semiconductor material, a sealing material containing, for example, an epoxy-based resin and silica is used. In a case where the sealing material is exposed to heat or light for a long period of time, a crack or the like may occur in the sealing material. Thus, a method of adding a stress reducing agent to a sealing material in order to ensure long-term reliability of the sealing material is widely used.

As such a stress reducing agent, a graft copolymer can be used.

For example, Patent Literature 1 discloses a graft copolymer that has been developed for the purpose of decreasing the elastic modulus of a curable resin composition and a molded product and improving the stress relaxation ability and that is obtained by polymerizing a graft vinyl monomer to a rubber containing a polyorganosiloxane and a poly(meth)acrylic acid alkyl ester, wherein the poly(meth)acrylic acid alkyl ester in the rubber contains a (meth)acrylic acid alkyl ester unit having an alkyl group having 5 to 13 carbon atoms.

Patent Literature 2 discloses a liquid epoxy resin composition for sealing that uses a graft copolymer having a relatively small amount of rubber.

In addition, although not a technology relating to a stress reducing agent, fine polymer particles disclosed in Patent Literature 3 are also a graft copolymer.

### CITATION LIST

### Patent Literature 1

Japanese Patent Application Publication Tokukai No. 2015-172185

### Patent Literature 2

Pamphlet of International Publication No. WO 2017/188286

### Patent Literature 3

Japanese Patent Application Publication Tokukai No. 2018-035210

However, the above-described conventional stress reducing agents have room for further improvement, from the viewpoint of (i) the dispersibility in a matrix resin and (ii) the linear expansion coefficient of a cured product of a resin composition containing a stress reducing agent and a matrix resin.

### SUMMARY

One or more embodiments of the present invention provide a stress reducing agent (i) that is excellent in dispersibility in a matrix resin and (ii) that enables provision of a cured product which has a favorable linear expansion coefficient when a resin composition containing the stress reducing agent and a matrix resin is cured.

As a result of conducting diligent studies in order to attain the above, the inventor completed one or more embodiments of the present invention.

That is, one or more embodiments of the present invention include the following configurations.

A stress reducing agent in accordance with one or more embodiments of the present invention is a stress reducing agent containing fine polymer particles (A), wherein: the fine polymer particles (A) contain a rubber-containing graft copolymer that includes an elastic body and a graft part grafted to the elastic body; a proportion of the elastic body contained in the fine polymer particles (A) is more than 70% by weight and not more than 97% by weight, with respect to 100% by weight of the fine polymer particles (A); the elastic body contains an organosiloxane-based rubber; the graft part contains an epoxy group-containing structural unit; the epoxy group-containing structural unit in the graft part is contained in an amount of 0.5% by weight to 4.0% by weight with respect to 100% by weight of the rubber-containing graft copolymer; and the stress reducing agent is a powdery and/or granular material.

Further, a stress reducing agent in accordance with one or more embodiments of the present invention is a stress reducing agent containing fine polymer particles (A), wherein: the fine polymer particles (A) contain a rubber-containing graft copolymer that includes an elastic body and a graft part grafted to the elastic body; a proportion of the elastic body contained in the fine polymer particles (A) is more than 70% by weight and not more than 97% by weight, with respect to 100% by weight of the fine polymer particles (A); the elastic body contains an organosiloxane-based rubber; the graft part contains an epoxy group-containing structural unit; the epoxy group-containing structural unit in the graft part is contained in an amount of 3.3% by weight to 26.7% by weight with respect to 100% by weight of the graft part in the rubber-containing graft copolymer; and the stress reducing agent is a powdery and/or granular material.

An aspect of one or more embodiments of the present invention brings about the effect of providing a stress reducing agent (i) that is excellent in dispersibility in a matrix resin and (ii) that enables provision of a cured product which has a favorable linear expansion coefficient when a resin composition containing the stress reducing agent and a matrix resin is cured.

### DETAILED DESCRIPTION OF THE EMBODIMENTS

The following description will discuss embodiments of the present invention. One or more embodiments of the present invention are not, however, limited to these embodiments. One or more embodiments of the present invention are not limited to the configurations described below, but may be altered in various ways within the scope of the claims. One or more embodiments of the present invention also encompass, in their technical scope, any embodiment or Example derived by combining technical means disclosed in one or more embodiments and Examples. Further, it is possible to form a new technical feature by combining the technical means disclosed in one or more embodiments. All academic and patent documents cited in the present specification are incorporated herein by reference. Any numerical range expressed as “A to B” in the present specification means “not less than A and not more than B (i.e., a range from A to B which includes both A and B)” unless otherwise stated.

### 1. Technical Idea of One or More Embodiments of the Present Invention

A stress reducing agent that is added to a sealing material (resin composition) to ensure long-term reliability may require a function of decreasing the elastic modulus of the sealing material. However, a decrease in the elastic modulus of the sealing material due to the stress reducing agent often causes deterioration in the linear expansion coefficient of the sealing material. That is, it has conventionally been difficult to achieve both the decrease in the elastic modulus of the sealing material due to the stress reducing agent and the maintenance of the linear expansion coefficient of the sealing material (reduction in the deterioration in the linear expansion coefficient) which are in a trade-off relationship. Note here that the deterioration in the linear expansion coefficient is intended to mean that a temperature rise expands the sealing material, in other words, the linear expansion coefficient increases.

In such a situation, the inventor of one or more embodiments of the present invention has conducted diligent studies to provide a stress reducing agent that enables provision of a cured product which has a low elastic modulus and has reduced deterioration in the linear expansion coefficient (in other words, a favorable linear expansion coefficient).

In the course of diligent studies, the inventor of one or more embodiments of the present invention has obtained, on his own, the following novel finding:

(1) A stress reducing agent containing fine polymer particles which contain a rubber-containing graft copolymer that includes an elastic body containing an organosiloxane-based rubber and a graft part grafted to the elastic body, surprisingly, enables provision of a cured product which has a low elastic modulus and has reduced deterioration in the linear expansion coefficient, that is, a favorable linear expansion coefficient; and

(2) A stress reducing agent containing the fine polymer particles in which the graft part contains an epoxy group-containing structural unit, surprisingly, enables provision of a cured product which has a low elastic modulus and has further reduced deterioration in the linear expansion coefficient, that is, a more favorable linear expansion coefficient.

A diene-based rubber has conventionally been used as an elastic body of a rubber-containing graft copolymer contained in a stress reducing agent. A stress reducing agent containing a rubber-containing graft copolymer that contains an elastic body which contains a diene-based rubber produces a small effect of reducing the deterioration in the linear expansion coefficient of a cured product due to an epoxy group-containing structural unit in a graft part. That is, the effect of reducing the deterioration in the linear expansion coefficient of the cured product due to the epoxy group-containing structural unit in the graft part is the effect that has been first found by the inventor of one or more embodiments of the present invention in a case where the inventor of one or more embodiments of the present invention has employed an elastic body that contains an organosiloxane-based rubber in the course of diligent studies, and is a distinct effect that could not be easily conceived of from the conventional common general technical knowledge.

In addition, in the course of diligent studies, the inventor of one or more embodiments of the present invention has also obtained, on his own, a novel finding that, in a case where the amount of the epoxy group-containing structural unit contained in the graft part exceeds a certain amount, surprisingly, the dispersibility of a stress reducing agent with respect to a matrix resin decreases. The dispersibility with respect to the matrix resin is also required of the stress reducing agent. Therefore, the inventor of one or more embodiments of the present invention has further conducted diligent studies in order to provide a stress reducing agent that enables provision of a cured product which has excellent dispersibility in a matrix resin, has a low elastic modulus, and has a favorable linear expansion coefficient.

As a result, the inventor of one or more embodiments of the present invention has completed one or more embodiments of the present invention by obtaining, on his own, the following novel finding: A stress reducing agent containing fine polymer particles which contain a rubber-containing graft copolymer that includes an elastic body containing an organosiloxane-based rubber and a graft part grafted to the elastic body and containing an epoxy group-containing structural unit in a specific amount, surprisingly, enables provision of a resin composition that enables provision of a cured product which (i) has excellent dispersibility in a matrix resin and (ii) has a low elastic modulus and a favorable linear expansion coefficient.

### 2. Stress Reducing Agent

A stress reducing agent in accordance with one or more embodiments of the present invention is a powdery and/or granular material and contains fine polymer particles (A). The fine polymer particles (A) contain a rubber-containing graft copolymer that includes an elastic body and a graft part grafted to the elastic body. A proportion of the elastic body contained in the fine polymer particles (A) is more than 70% by weight and not more than 97% by weight, with respect to 100% by weight of the fine polymer particles (A), the elastic body contains an organosiloxane-based rubber, and the graft part contains an epoxy group-containing structural unit. The epoxy group-containing structural unit in the graft part is contained in an amount of 0.5% by weight to 4.0% by weight with respect to 100% by weight of the rubber-containing graft copolymer.

Alternatively, in one or more embodiments of the present invention, the fine polymer particles (A) contain a rubber-containing graft copolymer that includes an elastic body and a graft part grafted to the elastic body, the proportion of the elastic body contained in the fine polymer particles (A) is more than 70% by weight and not more than 97% by weight, with respect to 100% by weight of the fine polymer particles (A), the elastic body contains an organosiloxane-based rubber, the graft part contains an epoxy group-containing structural unit, and the epoxy group-containing structural unit in the graft part is contained in an amount of 3.3% by weight to 26.7% by weight with respect to 100% by weight of the graft part of the rubber-containing graft copolymer.

Hereinafter, the “stress reducing agent in in accordance with one or more embodiments of the present invention” may also be referred to as “present stress reducing agent”. The present stress reducing agent has the above-described configuration and thus has an advantage of achieving excellent dispersibility of the fine polymer particles (A) in a matrix resin. In other words, the present stress reducing agent has the above-described configuration and thus has an advantage of providing a resin composition in which the fine polymer particles (A) are uniformly dispersed in a matrix resin by mixing of the stress reducing agent and the matrix resin. In addition, the present stress reducing agent has an advantage of providing a cured product which has a low elastic modulus and a favorable linear expansion coefficient by curing a resin composition containing the stress reducing agent and a matrix resin. In the present specification, “the deterioration in the linear expansion coefficient of the cured product is reduced” may be expressed as “linear expansion coefficient of the cured product is favorable”.

### (2-1. Fine Polymer Particles (A))

The fine polymer particles (A) contain a rubber-containing graft copolymer that includes an elastic body and a graft part grafted to the elastic body.

### (2-1-1. Elastic Body)

The elastic body contains an organosiloxane-based rubber. With the elastic body containing an organosiloxane-based rubber, the stress reducing agent enables provision of a cured product which has a low elastic modulus and a favorable linear expansion coefficient. Further, with the elastic body containing an organosiloxane-based rubber, the resin composition enables provision of a cured product which has sufficient heat resistance and excellent impact resistance at low temperatures. The elastic body can also be rephrased as an elastic part or rubber particles.

Examples of the organosiloxane-based rubber include (a) organosiloxane-based polymers composed of alkyl or aryl disubstituted silyloxy units, such as dimethylsilyloxy, diethylsilyloxy, methylphenylsilyloxy, diphenylsilyloxy, and dimethylsilyloxy-diphenylsilyloxy, and (b) organosiloxane-based polymers composed of alkyl or aryl monosubstituted silyloxy units, such as organohydrogensilyloxy in which some of sidechain alkyls have been substituted with hydrogen atoms. These organosiloxane-based polymers may be used alone or in combination of two or more thereof.

A cyclic siloxane composed of a plurality of dimethylsilyloxy units may be used as a raw material for the organosiloxane-based rubber. Examples of the cyclic siloxane include octamethylcyclotetrasiloxane (another name “D4”) having four dimethylsilyloxy units, decamethylcyclopentasiloxane (another name “D5”) having five dimethylsilyloxy units, and dodecamethylcyclohexane (another name “D6”) having six dimethylsilyloxy units.

In the present specification, for example, a polymer composed of a dimethylsilyloxy unit is referred to as a dimethylsilyloxy rubber, a polymer composed of a methylphenylsilyloxy unit is referred to as a methylphenylsilyloxy rubber, and a polymer composed of a dimethylsilyloxy unit and a diphenylsilyloxy unit is referred to as a dimethylsilyloxy-diphenylsilyloxy rubber. The organosiloxane-based rubber may be (a) at least one selected from the group consisting of dimethylsilyloxy rubbers, methylphenylsilyloxy rubbers, and dimethylsilyloxy-diphenylsilyloxy rubbers, because a more favorable linear expansion coefficient of a cured product is achieved, and a resulting resin composition enables provision of a cured product which has excellent heat resistance, and may be (b) a dimethylsilyloxy rubber because it is easily available and economical.

During the preparation of the organosiloxane-based rubber, a monomer containing (a) at least one hydrolyzable silyl group in a molecule and (b) at least one ethylenically unsaturated group and/or at least one mercapto group (hereinafter also referred to as “monomer M”) may be used as a raw material. In other words, the organosiloxane-based rubber may contain a structural unit derived from the monomer M (hereinafter also referred to as a “structural unit M”).

The hydrolyzable silyl group contained in the monomer M is not particularly limited. Examples of the hydrolyzable silyl group include a halogenosilyl group, an acyloxysilyl group, an amidesilyl group, an aminosilyl group, an alkenyloxysilyl group, an aminoxysilyl group, an oximesilyl group, an alkoxysilyl group, a thioalkoxysilyl group, and a silanol group. The hydrolyzable silyl group may be an alkoxysilyl group because it has high polymerization reactivity and is easily handled. In a case where the monomer M contains two or more hydrolyzable silyl groups in a molecule, the plurality of hydrolyzable silyl groups may be the same or different.

Specific examples of the monomer M include, for example, vinylsilanes such as vinylmethyldimethoxysilane, vinyltrimethoxysilane, vinyltriethoxysilane, and tetramethyltetravinylcyclotetrasiloxane; (meth)acryloyloxyalkylsilanes such as β-methacryloyloxyethyldimethoxymethylsilane, 3-(meth)acryloyloxypropyltrimethoxysilane, 3-(meth)acryloyloxypropyldimethoxymethylsilane, 3-(meth)acryloyloxypropylmethoxydimethylsilane, 3-(meth)acryloyloxypropyltriethoxysilane, 3-(meth)acryloyloxypropyldiethoxymethylsilane, 3-(meth)acryloyloxypropyldiethoxyethylsilane, 3-(meth)acryloyloxypropylethoxydimethylsilane, 3-(meth)acryloyloxypropylethoxydiethylsilane, and 5-(meth)acryloyloxybutyldiethoxymethylsilane; and mercaptoalkylsilanes such as 3-mercaptopropyltrimethoxysilane, 3-mercaptopropyldimethoxymethylsilane, 3-mercaptopropylmethoxymethidylsilane, 3-mercaptopropyltriethoxysilane, 3-mercaptopropyldiethoxymethylsilane, and 3-mercaptopropyldiethoxyethylsilane. In addition, specific examples of the monomer M include p-vinylphenylmethyldimethoxysilane, 2-(m-vinylphenyl)ethylmethyldimethoxysilane, 1-(m-vinylphenyl)methyldimethylisopropoxysilane, 2-(p-vinylphenyl)ethylmethyldimethoxysilane, 3-(p-vinylphenoxy)propylmethyldiethoxysilane, 3-(p-vinylbenzoyloxy)propylmethyldimethoxysilane, 1-(0-vinylphenyl)-1,1,2-trimethyl-2,2-dimethoxydisilane, 1-(p-vinylphenyl)-1,1-diphenyl-3-ethyl-3,3-diethoxydisiloxane, m-vinylphenyl-[3-(triethoxysilyl)propyl]diphenylsilane, and [3-(p-isopropenylbenzoylamino)propyl]phenyldipropoxysilane. One of these monomers M may be used alone, or two or more of these monomers M may be used in combination.

Among them, the monomer M may be the compounds that have been described above as specific examples of the (meth)acryloyloxyalkylsilanes and may be 3-(meth)acryloyloxypropyltrimethoxysilane and 3-(meth)acryloyloxypropyldimethoxymethylsilane. This configuration has an advantage of efficiently carrying out polymerization of a monomer mixture for forming the graft part in the presence of the organosiloxane-based rubber.

The organosiloxane-based rubber may contain the structural unit M in an amount of 0.001% by weight to 10.0% by weight, 0.001% by weight to 5.0% by weight, 0.01% by weight to 5.0% by weight, or 1.0% by weight to 5.0% by weight in 100% by weight of the organosiloxane-based rubber. This configuration has an advantage of efficiently carrying out polymerization of a monomer mixture for forming the graft part in the presence of the organosiloxane-based rubber.

The organosiloxane-based rubber contained in the elastic body may be composed of only one type of polyorganosiloxane-based rubber which has an identical structural unit composition or may be composed of two or more types of polyorganosiloxanes which differ in structural unit composition (type and content ratio) from each other.

The fine polymer particles (A) may contain the organosiloxane-based rubber in an amount of 60% by weight to 100% by weight, 70% by weight to 100% by weight, 80% by weight to 100% by weight, 90% by weight to 100% by weight, or 95% by weight to 100% by weight, with respect to 100% by weight of the elastic body contained in the fine polymer particles (A). According to this configuration, the present stress reducing agent enables provision of a cured product which has a more favorable linear expansion coefficient. The polymer fine particles (A) may contain 100% by weight of the organosiloxane-based rubber in the elastic body contained in the fine polymer particles (A), that is, the elastic body may be composed of only the organosiloxane-based rubber.

The elastic body may contain other one or more rubber(s) in addition to the organosiloxane-based rubber described above, within a range that does not impair an effect in accordance with one or more embodiments of the present invention. Examples of the other rubber(s) include a diene-based rubber, a (meth)acrylate-based rubber, and a natural rubber. A total amount of the other rubber(s) contained may be less than 40% by weight, less than 30% by weight, less than 20% by weight, less than 10% by weight, or less than 5% by weight, with respect to 100% by weight of the elastic body contained in the fine polymer particles (A).

Examples of the diene-based rubber include butadiene rubber which is constituted by a structural unit derived from 1,3-butadiene (also referred to as polybutadiene rubber) and butadiene-styrene rubber which is a copolymer of 1,3-butadiene and styrene (also referred to as polystyrene-butadiene).

Examples of the (meth)acrylate-based rubber include ethyl (meth)acrylate rubber, butyl (meth)acrylate rubber, and 2-ethylhexyl (meth)acrylate rubber.

### (Crosslinked Structure of Elastic Body)

The elastic body may have a crosslinked structure introduced therein, because stable dispersion of the fine polymer particles (A) in the matrix resin can be maintained. By using a polyfunctional alkoxysilane compound and/or a polyfunctional monomer during the preparation (polymerization) of the organosiloxane-based rubber, it is possible to introduce a crosslinked structure into the organosiloxane-based rubber. Therefore, it can also be said that the polyfunctional alkoxysilane compound and the polyfunctional monomer which are used for preparing the organosiloxane-based rubber are crosslinking agents in the organosiloxane-based rubber.

Examples of the polyfunctional alkoxysilane compounds include tetramethoxysilane, tetraethoxysilane (TEOS), tetraisopropoxysilane, tetrabutoxysilane, tetraoctylsilane, methyltrimethoxysilane, methyltriethoxysilane, ethyltriethoxysilane, methyltriisopropoxysilane, vinyltrimethoxysilane, phenyltrimethoxysilane, and dimethyldimethoxysilane.

It can also be said that the polyfunctional monomer is a monomer having two or more radical-polymerizable reactive groups in an identical molecule. The radical-polymerizable reactive groups may be each a carbon-carbon double bond. Examples of the polyfunctional monomer exclude butadiene and include (meth)acrylates having an ethylenically unsaturated double bond(s), such as allyl alkyl (meth)acrylates and allyl oxyalkyl (meth)acrylates. Examples of a monomer having two (meth)acrylic groups include ethylene glycol di(meth)acrylate, butylene glycol di(meth)acrylate, butanediol di(meth)acrylate, hexanediol di(meth)acrylate, cyclohexane dimethanol di(meth)acrylate, and polyethylene glycol di(meth)acrylates. Examples of the polyethylene glycol di(meth)acrylates include triethylene glycol di(meth)acrylate, tripropylene glycol di(meth)acrylate, tetraethylene glycol di(meth)acrylate, and polyethylene glycol (600) di(meth)acrylate. Examples of a monomer having three (meth)acrylic groups include alkoxylated trimethylolpropane tri(meth)acrylates, glycerol propoxy tri(meth)acrylate, pentaerythritol tri(meth)acrylate, and tris(2-hydroxyethyl)isocyanurate tri(meth)acrylate. Examples of the alkoxylated trimethylolpropane tri(meth)acrylates include trimethylolpropane tri(meth)acrylate and trimethylolpropane triethoxy tri(meth)acrylate. Examples of a monomer having four (meth)acrylic groups include pentaerythritol tetra(meth)acrylate and ditrimethylolpropane tetra(meth)acrylate. Examples of a monomer having five (meth)acrylic groups include dipentaerythritol penta(meth)acrylate. Examples of a monomer having six (meth)acrylic groups include ditrimethylolpropane hexa(meth)acrylate. Examples of the polyfunctional monomer also include diallyl phthalate, triallyl cyanurate, triallyl isocyanurate, and divinylbenzene.

### (Glass Transition Temperature of Elastic Body)

The elastic body may have a glass transition temperature of not higher than 80° C., not higher than 70° C., not higher than 60° C., not higher than 50° C., not higher than 40° C., not higher than 30° C., not higher than 20° C., not higher than 10° C., not higher than 0° C., not higher than −20° C., not higher than −40° C., not higher than −45° C., not higher than −50° C., not higher than −55° C., not higher than −60° C., not higher than −65° C., not higher than −70° C., not higher than −75° C., not higher than −80° C., not higher than −85° C., not higher than −90° C., not higher than −95° C., not higher than −100° C., not higher than −105° C., not higher than −110° C., not higher than −115° C., not higher than −120° C., or not higher than −125° C. In the present specification, the “glass transition temperature” may be referred to as “Tg”. With this configuration, it is possible to obtain fine polymer particles (A) having low Tg and a stress reducing agent having low Tg. As a result, a resin composition which contains the resulting stress reducing agent enables provision of a cured product which has excellent toughness. With the above-described configuration, the resin composition which contains the resulting stress reducing agent can have a lower viscosity. The Tg of the elastic body can be obtained by carrying out viscoelasticity measurement with use of a planar plate made of the fine polymer particles (A). Specifically, the Tg can be measured as follows: (1) a graph of tan δ is obtained by carrying out dynamic viscoelasticity measurement with respect to a planar plate made of the fine polymer particles (A), with use of a dynamic viscoelasticity measurement device (for example, DVA-200, manufactured by IT Keisoku Seigyo Kabushikigaisha) under a tension condition; and (2) in the graph of tan δ thus obtained, the peak temperature of tan δ is regarded as the glass transition temperature. Note, here, that in a case where a plurality of peaks are found in the graph of tan δ, the lowest peak temperature is regarded as the glass transition temperature of the elastic body.

In view of reduction of a decrease in elastic modulus (i.e., a decrease in rigidity) of the resulting cured product, i.e., in view of obtainment of the cured product which has a sufficient elastic modulus (rigidity), the Tg of the elastic body may be higher than 0° C., not lower than 20° C., not lower than 50° C., not lower than 80° C., or not lower than 120° C.

The Tg of the elastic body can be determined by, for example, the composition of the structural unit contained in the elastic body. In other words, it is possible to adjust the Tg of the resulting elastic body, by changing the composition of the monomer used to produce (form) the elastic body.

Note, here, that monomers each of which, when polymerized to form a homopolymer (i.e., a polymer obtained by polymerizing only one type of monomer), provides a homopolymer having a Tg of higher than 0° C. will be referred to as a monomer group “a”. Note also that monomers each of which, when polymerized to form a homopolymer (i.e., a polymer obtained by polymerizing only one type of monomer), provides a homopolymer having a Tg of lower than 0° C. will be referred to as a monomer group “b”. Note also that an elastic body containing (i) one or more structural units derived from at least one type of monomer selected from the monomer group “a” in an amount of 50% by weight to 100% by weight (or 65% by weight to 99% by weight) and (ii) one or more structural units derived from at least one type of monomer selected from the monomer group “b” in an amount of 0% by weight to 50% by weight (or 1% by weight to 35% by weight) will be referred to as an elastic body X. The elastic body X has a Tg higher than 0° C. In a case where the elastic body includes the elastic body X, a resin composition which contains the resulting stress reducing agent enables provision of a cured product which has sufficient rigidity.

Also in a case where the Tg of the elastic body is higher than 0° C., it is preferable that the crosslinked structure be introduced in the elastic body. Examples of a method of introducing the crosslinked structure into the elastic body include the above-described methods.

Examples of the monomers which can be included in the monomer group “a” include, but are not limited to, unsubstituted vinyl aromatic compounds such as styrene and 2-vinyl naphthalene; vinyl-substituted aromatic compounds such as α-methyl styrene; ring-alkylated vinyl aromatic compounds such as 3-methylstyrene, 4-methylstyrene, 2,4-dimethylstyrene, 2,5-dimethylstyrene, 3,5-dimethylstyrene, and 2,4,6-trimethylstyrene; ring-alkoxylated vinyl aromatic compounds such as 4-methoxystyrene and 4-ethoxystyrene; ring-halogenated vinyl aromatic compounds such as 2-chlorostyrene and 3-chlorostyrene; ring-ester-substituted vinyl aromatic compounds such as 4-acetoxy styrene; ring-hydroxylated vinyl aromatic compounds such as 4-hydroxystyrene; vinyl esters such as vinyl benzoate and vinyl cyclohexanoate; vinyl halides such as vinyl chloride; aromatic monomers such as acenaphthalene and indene; alkyl methacrylates such as methyl methacrylate, ethyl methacrylate, and isopropyl methacrylate; aromatic methacrylates such as phenyl methacrylate; methacrylates such as isobornyl methacrylate and trimethylsilyl methacrylate; methacrylic acid derivative-containing methacryl monomers such as methacrylonitrile; certain types of acrylic acid esters such as isobornyl acrylate and tert-butyl acrylate; and acrylic acid derivative-containing acrylic monomers such as acrylonitrile. Examples of the monomers which can be included in the monomer group “a” further include monomers each of which, when polymerized, enables provision of a homopolymer having a Tg of not lower than 120° C., such as acrylamide, isopropyl acrylamide, N-vinylpyrrolidone, isobornyl methacrylate, dicyclopentanyl methacrylate, 2-methyl-2-adamanthyl methacrylate, 1-adamanthyl acrylate, and 1-adamanthyl methacrylate. These monomers “a” may be used alone or in combination of two or more thereof.

Examples of monomers “b” include ethyl acrylate, butyl acrylate, 2-ethylhexyl acrylate, octyl (meth)acrylate, dodecyl (meth)acrylate, 2-hydroxyethyl acrylate, and 4-hydroxybutyl acrylate. These monomers “b” may be used alone or in combination of two or more thereof. Out of these monomers “b”, ethyl acrylate, butyl acrylate, and 2-ethylhexyl acrylate are particularly preferable.

### (Volume-Average Particle Size of Elastic Body)

The elastic body may have a volume-average particle size of 0.03 μm to 50.00 μm, 0.05 μm to 10.00 μm, 0.08 μm to 2.00 μm, 0.10 μm to 1.00 μm, 0.10 μm to 0.80 μm, or 0.10 μm to 0.50 μm. In a case where the volume-average particle size of the elastic body is not less than 0.03 μm, the elastic body which has a desired volume-average particle size can be stably obtained. In a case where the volume-average particle size of the elastic body is not more than 50.00 μm, the resulting cured product has favorable heat resistance and favorable impact resistance. The volume-average particle size of the elastic body can be measured with use of a dynamic light scattering type particle size distribution measurement apparatus using, as a test specimen, an aqueous latex containing the elastic body. A method of measuring the volume-average particle size of the elastic body will be described later in detail in Examples.

### (Proportion of Elastic Body)

A proportion of the elastic body contained in the fine polymer particles (A) may be more than 70% by weight and not more than 97% by weight, more than 70% by weight and not more than 95% by weight, or more than 70% by weight and not more than 93% by weight, where 100% by weight represents the entirety of the fine polymer particles (A). In the case where the proportion of the elastic body is more than 70% by weight, a resin composition which contains the resulting stress reducing agent enables provision of a cured product which has excellent toughness and excellent impact resistance. In a case where the proportion of the elastic body is not more than 97% by weight, the fine polymer particles (A) do not easily agglutinate (i.e., less likely to agglutinate), and therefore a resin composition which contains the resulting stress reducing agent does not have a high viscosity. As a result, the resin composition can be handled easily. Conventionally, in a case where the proportion of the elastic body in the fine polymer particles (A) is more than 70% by weight, the elastic modulus of a cured product can be effectively decreased due to a high proportion of the elastic body, but there is a tendency that the dispersibility of a powdery and/or granular material in the matrix resin is likely to deteriorate due to a low proportion of the graft part. However, according to one or more embodiments of the present invention, even in a case where the proportion of the elastic body in the fine polymer particles (A) is more than 70% by weight, it is possible to achieve stress reduction of a cured product that includes a resin composition which has favorable dispersibility in the matrix resin and contains the stress reducing agent and the matrix resin.

### (Gel Content of Elastic Body)

The elastic body may be one that can swell in an appropriate solvent but is substantially insoluble in the appropriate solvent. The elastic body may be insoluble in a matrix resin used.

The elastic body may have a gel content of not less than 60% by weight, not less than 80% by weight, not less than 90% by weight, or not less than 95% by weight. In a case where the gel content of the elastic body falls within the above range, a resin composition which contains the resulting stress reducing agent enables provision of a cured product which has excellent toughness.

In the present specification, a method of calculating the gel content is as follows. First, an aqueous latex containing the fine polymer particles (A) is obtained. Next, a powdery and/or granular material of the fine polymer particles (A) is obtained from the aqueous latex. A method of obtaining the powdery and/or granular material of the fine polymer particles (A) from the aqueous latex is not limited to any particular one, and examples thereof include a method of obtaining the powdery and/or granular material of the fine polymer particles (A) by (i) causing the fine polymer particles (A) in the aqueous latex to agglutinate, (ii) dehydrating the agglutinate thus obtained, and (iii) further drying the agglutinate. Next, 2.0 g of the powdery and/or granular material of the fine polymer particles (A) is dissolved in 50 mL of methyl ethyl ketone (MEK). The MEK solution of the powder thus obtained is separated into a part soluble in MEK (MEK-soluble part) and a part insoluble in MEK (MEK-insoluble part). Specifically, the obtained MEK solution of the powder is subjected to centrifugal separation with use of a centrifugal separator (CP60E, manufactured by Hitachi Koki Co., Ltd.) at 30000 rpm for 1 hour, and thereby separated into the MEK-soluble part and the MEK-insoluble part. Note, here, that three sets of centrifugal separations are carried out in total. The weight of the MEK-soluble part and the weight of the MEK-insoluble part are measured, and then the gel content is calculated with use of the following expression.

Gel content (%)=(weight of methyl ethyl ketone insoluble part)/{(weight of methyl ethyl ketone insoluble part)+(weight of methyl ethyl ketone soluble part)}×100

### (Variations of Elastic Body)

In one or more embodiments of the present invention, the “elastic body” of the fine polymer particles (A) may be constituted by one type of elastic body which has an identical structural unit composition. In such a case, the “elastic body” of the fine polymer particles (A) is one type selected from among organosiloxane-based rubbers.

In one or more embodiments of the present invention, the “elastic body” of the fine polymer particles (A) may be constituted by a plurality of types of elastic bodies which differ in structural unit composition from each other. In such a case, the “elastic body” of the fine polymer particles (A) may be two or more types selected from among organosiloxane-based rubbers. Alternatively, the “elastic body” of the fine polymer particles (A) may be a mixture of one type selected from among organosiloxane-based rubbers and at least one type selected from among the above-listed other rubbers such as diene-based rubbers and (meth)acrylate-based rubbers.

In one or more embodiments of the present invention, a case where the “elastic body” of the fine polymer particles (A) is composed of a plurality of types of elastic bodies which differ in structural unit composition from each other will be described. In this case, the plurality of types of elastic bodies will be referred to as an elastic body₁, an elastic body₂, . . . and an elastic bodyₙ, respectively. Note, here, that “n” is an integer of 2 or more. The “elastic body” of the fine polymer particles (A) may include a complex of the elastic body₁, the elastic body₂, . . . , and the elastic bodyₙ which have been separately formed by polymerization. The “elastic body” of the fine polymer particles (A) may include one elastic body obtained by forming the elastic body₁, the elastic body₂, . . . , and the elastic bodyₙ in order by polymerization. Forming a plurality of elastic bodies (polymers) by polymerization in order in this manner is also referred to as multistage polymerization. One elastic body obtained by multistage polymerization of a plurality of types of elastic bodies is also referred to as a multistage-polymerization elastic body. A method of producing a multistage-polymerization elastic body will be later described in detail.

A multistage-polymerization elastic body constituted by the elastic body₁, the elastic body₂, . . . and the elastic bodyₙ will be described. In the multistage-polymerization elastic body, the elastic bodyₙ can cover at least part of an elastic bodyₙ₋₁ or the whole of the elastic bodyₙ₋₁. In the multistage-polymerization elastic body, part of the elastic bodyₙ may be located inside the elastic bodyₙ₋₁.

In the multistage-polymerization elastic body, the plurality of elastic bodies may form a layer structure. For example, in a case where the multistage-polymerization elastic body is constituted by the elastic body₁, the elastic body₂, and an elastic body₃, aspects of one or more embodiments of the present invention also include an aspect in which the elastic body₁ forms the innermost layer, a layer of the elastic body₂ is formed on the outer side of the elastic body₁, and a layer of the elastic body₃ is formed on the outer side of the layer of the elastic body₂ as the outermost layer of the elastic body. Thus, it can also be said that the multistage-polymerization elastic body in which the plurality of elastic bodies form a layer structure is a multilayered elastic body. In other words, in one or more embodiments of the present invention, the “elastic body” of the fine polymer particles (A) may include (a) a complex of a plurality of types of elastic bodies, (b) a multistage-polymerization elastic body, and/or (c) a multilayered elastic body.

### (2-1-2. Graft Part)

In the present specification, a polymer grafted to the elastic body is referred to as a graft part. The fine polymer particles (A) contain a rubber-containing graft copolymer that includes the elastic body and a graft part grafted to the elastic body. The graft part can play various roles. The “various roles” are, for example, (a) to improve compatibility between the matrix resin and the fine polymer particles (A), (b) to improve the dispersibility of the fine polymer particles (A) in the matrix resin, and (c) to allow the fine polymer particles (A) to be dispersed in the form of primary particles in a resin composition which contains the resulting stress reducing agent or in a cured product.

The graft part contains, as a structural unit, an epoxy group-containing structural unit, in other words, a structural unit including an epoxy group. In a case where the graft part contains a structural unit derived from an epoxy group-containing monomer such as glycidyl methacrylate, the stress reducing agent has an advantage of providing a cured product which has a more favorable linear expansion coefficient. In the preparation of the graft part, it is possible to obtain the graft part containing an epoxy group-containing structural unit by using (polymerizing) a mixture which contains a monomer having an epoxy group (monomer mixture for forming the graft part).

Specific examples of the monomer having an epoxy group include glycidyl-group-containing vinyl monomers such as glycidyl (meth)acrylates, 4-hydroxybutyl (meth)acrylate glycidyl ethers, and allyl glycidyl ethers. One of these monomers may be used alone, or two or more of these monomers may be used in combination. The monomer having an epoxy group may be glycidyl methacrylate because it is easily available and economical.

The graft part may contain the epoxy group-containing structural unit in an amount of 0.5% by weight to 4.0% by weight, 0.6% by weight to 3.8% by weight, 0.7% by weight to 3.5% by weight, 0.8% by weight to 3.3% by weight, not less than 0.8% by weight and less than 3.2% by weight, 0.9% by weight to 3.0% by weight, or not less than 1.0% by weight and less than 3.0% by weight, with respect to 100% by weight of the rubber-containing graft copolymer. The configuration in which the graft part contains the epoxy group-containing structural unit in an amount of not less than 0.5% by weight with respect to 100% by weight of the rubber-containing graft copolymer has an advantage in that the linear expansion coefficient of a cured product which contains the resin composition obtained by adding the stress reducing agent to the matrix resin significantly decreases, that is, the stress reducing agent enables provision of a cured product which has a more favorable linear expansion coefficient. Further, with the graft part containing the epoxy group-containing structural unit in an amount of not more than 4.0% by weight with respect to 100% by weight of the rubber-containing graft copolymer, the stress reducing agent has an advantage of having excellent dispersibility with respect to the matrix resin.

Further, the graft part may contain, as a structural unit, an epoxy group-containing structural unit in an amount of 3.3% by weight to 26.7% by weight, 4.0% by weight to 25.0% by weight, 5.0% by weight to 22.0% by weight, or 6.0% by weight to 20.0% by weight, with respect to 100% by weight (all) of the structural units of the graft part in the rubber-containing graft copolymer. The configuration in which the graft part contains the epoxy group-containing structural unit in an amount of not less than 3.3% by weight with respect to 100% by weight (all) of the structural units of the graft part has an advantage in that the linear expansion coefficient of a cured product which contains the resin composition obtained by adding the stress reducing agent to the matrix resin significantly decreases, that is, the stress reducing agent enables provision of a cured product which has a more favorable linear expansion coefficient. Further, with the graft part containing the epoxy group-containing structural unit in an amount of not more than 26.7% by weight with respect to 100% by weight (all) of the structural units of the graft part, the stress reducing agent has an advantage of having excellent dispersibility with respect to the matrix resin.

Above all, it is more preferable that the graft part contain the epoxy group-containing structural unit in an amount within the above-described range with respect to 100% by weight of the rubber-containing graft copolymer, and contain the epoxy group-containing structural unit in an amount within the above-described range with respect to 100% by weight (all) of the structural units of the graft part in the rubber-containing graft copolymer.

Furthermore, the graft part may contain, as a structural unit, a structural unit that does not contain an epoxy group which is a structural unit derived from at least one monomer selected from the group consisting of an aromatic vinyl monomer that does not contain an epoxy group, a vinyl cyanide monomer that does not contain an epoxy group, and a (meth)acrylate monomer that does not contain an epoxy group.

The above-described at least one monomer selected from the group consisting of the aromatic vinyl monomer, the vinyl cyanide monomer, and the (meth)acrylate monomer may be used alone or in combination of two or more.

The graft part may contain, as a structural unit, a structural unit derived from an aromatic vinyl monomer that does not contain an epoxy group, a structural unit derived from a vinyl cyanide monomer that does not contain an epoxy group, and/or a structural unit derived from a (meth)acrylate monomer that does not contain an epoxy group in an amount of 10% by weight to 97% by weight in total, 30% by weight to 96% by weight in total, 50% by weight to 95% by weight in total, 60% by weight to 94% by weight in total, or 70% by weight to 94% by weight in total, in 100% by weight (all) of the structural units of the graft part.

The graft part may contain, as a structural unit, a structural unit derived from a monomer having a reactive group other than an epoxy group. Examples of the monomer having a reactive group other than an epoxy group include monomers each having an oxetane group, a hydroxy group, an amino group, an imide group, a carboxylic acid group, a carboxylic anhydride group, a cyclic ester, a cyclic amide, a benzoxazine group, a cyanate ester group, or the like group.

The graft part may contain, as a structural unit, a structural unit derived from a polyfunctional monomer. In a case where the graft part contains a structural unit derived from a polyfunctional monomer, there are, for example, the following advantages: (a) it is possible to prevent swelling of the fine polymer particles (A) in the resin composition which contains the resulting stress reducing agent; (b) since the resin composition which contains the resulting stress reducing agent has a low viscosity, the resin composition tends to have favorable handleability; and (c) the dispersibility of the fine polymer particles (A) in the matrix resin improves in the resin composition.

In a case where the graft part does not contain a structural unit derived from a polyfunctional monomer, the resin composition which contains the resulting stress reducing agent enables provision of a cured product which has more excellent toughness and more excellent impact resistance, as compared to a case where the graft part contains a structural unit derived from a polyfunctional monomer.

Specific examples of the polyfunctional monomer are the same as those described in the section under (Crosslinked structure of elastic body) above. Therefore, the description thereof will be incorporated and will be omitted here.

The graft part may contain, as a structural unit, a structural unit derived from another monomer, in addition to the structural unit(s) derived from the above-listed monomer(s).

### (Glass Transition Temperature of Graft Part)

The graft part may have a glass transition temperature of not higher than 190° C., not higher than 160° C., not higher than 140° C., not higher than 120° C., not higher than 80° C., not higher than 70° C., not higher than 60° C., not higher than 50° C., not higher than 40° C., not higher than 30° C., not higher than 20° C., not higher than 10° C., not higher than 0° C., not higher than −20° C., not higher than −40° C., not higher than −45° C., not higher than −50° C., not higher than −55° C., not higher than −60° C., not higher than −65° C., not higher than −70° C., not higher than −75° C., not higher than −80° C., not higher than −85° C., not higher than −90° C., not higher than −95° C., not higher than −100° C., not higher than −105° C., not higher than −110° C., not higher than −115° C., not higher than −120° C., or not higher than −125° C.

The glass transition temperature of the graft part may be not lower than 0° C., not lower than 30° C., not lower than 50° C., not lower than 70° C., not lower than 90° C., or not higher than 110° C.

The Tg of the graft part can be determined by, for example, the composition of the structural unit contained in the graft part. In other words, it is possible to adjust the Tg of the resulting graft part, by changing the composition of the monomer used to produce (form) the graft part.

As to the Tg of the graft part, a graph of tan δ is obtained in the same manner as the measurement of the Tg of the elastic body. In a case where a plurality of peaks are found in the obtained graph of tan δ, the highest peak temperature is regarded as the glass transition temperature of the graft part.

### (Graft Rate of Graft Part)

In one or more embodiments of the present invention, the fine polymer particles (A) may have a polymer which is identical in composition to the graft part and which is not grafted to the elastic body. In the present specification, the polymer which is identical in composition to the graft part and which is not grafted to the elastic body may be referred to as a “non-grafted polymer”. It can also be said that the non-grafted polymer is a polymer that is not grafted to the elastic body, out of polymers produced during formation of the graft part by polymerization.

In the present specification, the proportion of (i) the polymer which is grafted to the elastic body to (ii) the polymers produced in the step of preparing the graft part, i.e., the proportion of the graft part, is referred to as a “graft rate”. In other words, the graft rate is a value represented by the following expression:

(weight of graft part)/{(weight of graft part)+(weight of non-grafted polymer)}×100.

Furthermore, in the step of preparing the graft part, a soluble part may also be present in addition to the graft part and the non-grafted polymer. The soluble part is intended to mean monomers not polymerized and auxiliary materials such as an initiator.

The graft copolymer (A), a non-grafted polymer, and a soluble part can be distinguished by, for example, a method for determining the solubility/insolubility in a solvent. Examples of such a method include a method in which (i) the graft copolymer (A) are identified if insoluble in MEK, (ii) a non-grafted polymer is identified if soluble in MEK but insoluble in methanol, and (iii) a soluble part is identified if soluble in both MEK and methanol.

The graft rate of the graft part may be not less than 70%, not less than 80%, or not less than 90%. In a case where the graft rate is not less than 70%, there is an advantage that the viscosity of the resin composition which contains the resulting stress reducing agent does not become too high.

As described above, the fine polymer particles (A) and the non-grafted polymer are separable with use of a solvent. However, in the present specification, the non-grafted polymer also constitutes a part of the fine polymer particles (A) in accordance with one or more embodiments of the present invention. For example, in a case where the weight of the fine polymer particles (A) is referred to in one or more embodiments of the present invention, the “weight of the fine polymer particles (A)” is intended to mean a total weight of the weight of the fine polymer particles (A) which are a part insoluble in MEK and the weight of the non-grafted polymer which is a part soluble in MEK and which is a part insoluble in methanol.

The weight of the polymer of the graft part is the amount of monomer introduced for formation of the polymer of the graft part. In calculation of the graft rate, a method of causing the fine polymer particles (A) to coagulate is not limited to any particular one, and a method in which a solvent is used, a method in which a coagulant is used, a method in which an aqueous latex is sprayed, or the like can be employed.

### (Variations of Graft Part)

In one or more embodiments of the present invention, the graft part may be constituted by only one type of graft part which contains only one type of structural unit. In one or more embodiments of the present invention, the graft part may be constituted by a plurality of types of graft parts which have structural units different from each other in composition.

A case where the graft part is constituted by a plurality of types of graft parts in one or more embodiments of the present invention will be described. In this case, the plurality of types of graft parts will be referred to as a graft part₁, a graft part₂, . . . a graft partₙ (“n” is an integer of 2 or more). The graft part may include a complex of the graft part₁, the graft part₂ . . . , and the graft partₙ which are separately formed by polymerization. The graft part may include a polymer obtained by forming the graft part₁, the graft part₂, . . . , and the graftₙ part, by multistage polymerization. A polymer obtained by multistage polymerization of a plurality of types of graft parts is also referred to as a multistage-polymerization graft part. A method of producing a multistage-polymerization graft part will be later described in detail.

In a case where the graft part is constituted by the plurality of types of graft parts, all of the plurality of types of graft parts do not need to be grafted to the elastic body. It is only necessary that at least part of at least one of the plurality of types of graft parts be grafted to the elastic body. The other of the plurality of types of graft parts (the other types of graft parts) may be grafted to the at least one of the plurality of types of graft parts which is grafted to the elastic body. In a case where the graft part is constituted by the plurality of types of graft parts, the graft part may have a plurality of types of polymers which are identical in composition to the plurality of types of graft parts and which are not grafted to the elastic body (a plurality of types of non-grafted polymers).

The multistage-polymerization graft part constituted by the graft part₁, the graft part₂, . . . the graft partₙ will be described. In the multistage-polymerization graft part, the graft partₙ can cover at least part of a graft partₙ₋₁ or the whole of the graft partₙ₋₁. In the multistage-polymerization graft part, part of the graft partₙ may be located inside the graft partₙ₋₁.

In the multistage-polymerization graft part, the graft parts may form a layer structure. For example, in a case where the multistage-polymerization graft part is constituted by the graft part₁, the graft part₂, and a graft part₃, aspects of one or more embodiments of the present invention also include an aspect in which the graft part₁ forms the innermost layer of the graft part, a layer of the graft part₂ is formed on the outer side of the graft part₁, and a layer of the graft part₃ is formed on the outer side of the layer of the graft part₂ as the outermost layer. Thus, it can also be said that the multistage-polymerization graft part in which the graft parts form a layer structure is a multilayered graft part. In other words, in one or more embodiments of the present invention, the graft part may include (a) a mixture of plurality of types of graft parts, (b) a multistage-polymerization graft part, and/or (c) a multilayered graft part.

In a case where the elastic body and the graft part are formed in this order by polymerization in production of the fine polymer particles (A), at least part of the graft part can cover at least part of the elastic body in the resulting fine polymer particles (A). The wording “the elastic body and the graft part are formed in this order by polymerization” can be reworded as follows: the elastic body and the graft part are subjected to multistage polymerization. It can also be said that the fine polymer particles (A) obtained by multistage polymerization of the elastic body and the graft part are a multistage polymer.

In a case where the fine polymer particles (A) are constituted by a multistage polymer, the graft part can cover at least part of the elastic body or the whole of the elastic body. In a case where the fine polymer particles (A) are constituted by a multistage polymer, part of the graft part may be located inside the elastic body.

In a case where the fine polymer particles (A) are constituted by a multistage polymer, the elastic body and the graft part may form a layer structure. For example, aspects of one or more embodiments of the present invention also include an aspect in which the elastic body forms the innermost layer (also referred to as a core layer) and a layer of the graft part is formed on the outer side of the elastic body as the outermost layer (also referred to as a shell layer). It can also be said that a structure in which the elastic body is present as a core layer and the graft part is present as a shell layer is a core-shell structure. It can also be said that the fine polymer particles (A) that contain the elastic body and the graft part which form a layer structure (core-shell structure) are constituted by a multilayered polymer or a core-shell polymer. In other words, in one or more embodiments of the present invention, the fine polymer particles (A) may be constituted by a multistage polymer and/or a multilayered polymer or a core-shell polymer. Note, however, that the fine polymer particles (A) are not limited to the above configuration, provided that the graft part is grafted to the elastic body.

At least part of the graft part may cover at least part of the elastic body. In other words, at least part of the graft part may be present on the outermost side of the fine polymer particles (A).

### (2-1-3. Surface-Crosslinked Polymer)

The rubber-containing graft copolymer may further have a surface-crosslinked polymer in addition to the elastic body and the graft part grafted to the elastic body. In a case where the rubber-containing graft copolymer further has the surface-crosslinked polymer, the following advantages are achieved: an anti-blocking property can be improved in the production of the fine polymer particles (A); and (b) the dispersibility of the fine polymer particles (A) in the matrix resin becomes more favorable in the resin composition which contains the resulting stress reducing agent. In a case where the rubber-containing graft copolymer further has the surface-crosslinked polymer, the following effects can be further achieved: (a) an effect of decreasing the viscosity of the resin composition which contains the resulting stress reducing agent; (b) an effect of increasing the crosslinking density of the elastic body; and (c) an effect of increasing the graft efficiency of the graft part. Note that the crosslinking density of the elastic body means a degree of the number of crosslinked structures in the entirety of the elastic body.

The surface-crosslinked polymer is constituted by a polymer containing, as structural units, (i) a structural unit(s) derived from a polyfunctional monomer(s) in an amount of 30% by weight to 100% by weight and (ii) a structural unit(s) derived from a vinyl-based monomer(s), other than the unit(s) derived from polyfunctional monomer(s), in an amount of 0% by weight to 70% by weight, which total 100% by weight.

Specific examples of the polyfunctional monomer are the same as those described in the section under (Crosslinked structure of elastic body) above. Therefore, the description thereof will be incorporated and will be omitted here.

### (2-1-4. Physical Properties of Fine Polymer Particles (A))

The following description will discuss physical properties of the fine polymer particles (A).

### (Volume-Average Particle Size (Mv) of Fine Polymer Particles (A))

The volume-average particle size (Mv) of the fine polymer particles (A) may be 0.03 μm to 50.00 μm, 0.05 μm to 10.00 μm, 0.08 μm to 2.00 μm, 0.10 μm to 1.00 μm, 0.10 μm to 0.80 μm, or 0.10 μm to 0.50 μm, because it is possible to obtain a resin composition which has a desired viscosity and which is highly stable. In a case where the volume-average particle size (Mv) of the fine polymer particles (A) falls within the above range, there is also an advantage that the dispersibility of the fine polymer particles (A) in a matrix resin is favorable. Note that, in the present specification, the “volume-average particle size (Mv) of the fine polymer particles (A)” means the volume-average particle size of the primary particles of the fine polymer particles (A) unless otherwise mentioned. The volume-average particle size of the fine polymer particles (A) can be measured with use of a dynamic light scattering type particle size distribution measurement apparatus using, as a test specimen, an aqueous latex containing the fine polymer particles (A). The volume-average particle size of the fine polymer particles (A) will be described later in detail in Examples. The volume-average particle size of the fine polymer particles (A) can also be measured by (i) cutting a cured product obtained from the resin composition, (ii) capturing an image of a cut surface with use of an electron microscope or the like, and (iii) using image data thus obtained (captured image).

The particle-number-based distribution of the volume-average particle size of the fine polymer particles (A) in the matrix resin may have a full width at half maximum which is not less than 0.5 times and not more than 1 time the volume-average particle size, because the resin composition which has a low viscosity and is easy to handle is obtained.

### (2-1-5. Method of Producing Fine Polymer Particles (A))

The fine polymer particles (A) can be produced as follows: after an elastic body is formed by polymerization, the polymer which constitutes the graft part is graft polymerized to the elastic body in the presence of the elastic body.

The fine polymer particles (A) can be produced by a known method, for example, a method such as an emulsion polymerization method, a suspension polymerization method, or a microsuspension polymerization method. Specifically, the formation of the elastic body by polymerization in the fine polymer particles (A), the formation of the graft part by polymerization in the fine polymer particles (A) (graft polymerization), and the formation of the surface-crosslinked polymer by polymerization in the fine polymer particles (A) can be each achieved by a known method, for example, a method such as an emulsion polymerization method, a suspension polymerization method, or a microsuspension polymerization method. Out of these methods, the emulsion polymerization method is particularly preferable as the method of producing the fine polymer particles (A). The emulsion polymerization method has the following advantages: it facilitates (a) compositional design of the fine polymer particles (A), (b) industrial production of the fine polymer particles (A), and (c) obtainment of the aqueous latex of the fine polymer particles (A) which can be suitably used to produce the present resin composition (described later). A method of producing the elastic body which can be contained in the fine polymer particles (A), a method of producing the graft part which can be contained in the fine polymer particles (A), and a method of producing the surface-crosslinked polymer which can be optionally contained in the fine polymer particles (A) will be described below.

### (Method of Producing Elastic Body)

A method of preparing the organosiloxane-based rubber is not particularly limited, and a known emulsion polymerization method can be used. Specifically, a method of preparing the organosiloxane-based rubber includes a method in which emulsion polymerization of an organosiloxane and the monomer M is carried out in the presence of an acidic emulsifying agent.

Preferable as the organosiloxane that is a raw material used in the preparation of the organosiloxane-based rubber are various types of organosiloxane-based ring forms each having a 3 or more-membered ring such as hexamethylcyclotrisiloxane, octamethylcyclotetrasiloxane, decamethylcyclopentasiloxane, dodecamethylcyclohexasiloxane, trimethyltriphenylcyclotrisiloxane, tetradecamethylcycloheptasiloxane, and dimethylcyclics (a mixture of a trimer to heptanomer of dimethyl siloxane-cyclic oligomer), because they are easily available and make it easy to prepare the organosiloxane-based rubber.

The acidic emulsifying agent is not particularly limited. However, in a case where an organosiloxane-based ring form is used, the acidic emulsifying agent may be an acidic emulsifying agent that enables ring-opening of the organosiloxane-based ring form. Examples of the acidic emulsifying agent suitably include dodecylbenzenesulfonic acid. The amount of the acidic emulsifying agent used is not particularly limited, and may be set as appropriate according to, for example, (a) desired volume-average particle sizes of the organosiloxane-based rubber and the fine polymer particles (A), (b) the concentration of a solid content (monomer mixture) in a reaction solution, (c) the polymerization condition such as the polymerization temperature, and (d) whether an additive such as a surfactant is used and the amount of the additive used.

The volume-average particle size of the obtained organosiloxane-based rubber can be controlled by, for example, (a) the degree of pre-dispersion of a raw material, (b) the amount of emulsifying agent used, (c) the polymerization temperature, and (d) a method of supplying a raw material.

In a case where the organosiloxane-based rubber is obtained by emulsion polymerization performed in the presence of an acidic emulsifying agent, it is preferable that a resulting aqueous latex, which is strongly acid, be neutralized after the end of the polymerization reaction. A basic compound used for the neutralization is not particularly limited, and examples thereof include sodium hydroxide, potassium hydroxide, ammonium, and triethylamine. By adding these basic compounds directly or in the form of an aqueous solution to the aqueous latex containing the organosiloxane-based rubber, it is possible to neutralize the aqueous latex.

As the method of preparing the organosiloxane-based rubber, a method described in, for example, WO 2006/070664 can be used.

In a case where the elastic body includes at least one type of elastic body selected from the group consisting of diene-based rubbers and (meth)acrylate-based rubbers, these elastic bodies can be produced by, for example, a method such as emulsion polymerization, suspension polymerization, or microsuspension polymerization. As such a production, a method described in, for example, WO 2005/028546 can be used.

### (Method of Producing Graft Part)

The graft part can be formed, for example, by polymerizing, by known radical polymerization, the monomer used to form the graft part. In a case where (a) the elastic body is obtained as an aqueous latex or (b) a fine polymer particle precursor containing the elastic body and the surface-crosslinked polymer is obtained as an aqueous latex, the graft part may be formed by emulsion polymerization. The graft part can be produced by a method disclosed in, for example, WO 2005/028546.

In a case where the graft part is constituted by the plurality of types of graft parts, the fine polymer particles (A) may be produced as follows: the graft part which is constituted by the plurality of types of graft parts is formed by polymerization, and then these graft parts are graft polymerized to the elastic body. The fine polymer particles (A) may be produced as follows: in the presence of the elastic body, a plurality of types of polymers which constitute the graft part are formed in order by multistage graft polymerization with respect to the elastic body.

In a case where emulsion polymerization is employed as the method of preparing the diene-based rubber and the (meth)acrylate-based rubber and/or as the method of preparing the graft part, a known emulsifying agent (dispersion agent) can be used.

Examples of the emulsifying agent include anionic emulsifying agents, nonionic emulsifying agents, polyvinyl alcohols, alkyl-substituted celluloses, polyvinylpyrrolidone, and polyacrylic acid derivatives. Examples of the anionic emulsifying agent include sulfur-based emulsifying agents, phosphorus-based emulsifying agents, sarcosine acid-based emulsifying agents, and carboxylic acid-based emulsifying agents. Examples of the sulfur-based emulsifying agent include sodium dodecylbenzenesulfonate (abbreviated as SDBS). Examples of the phosphorus-based emulsifying agent include sodium polyoxyethylene lauryl ether phosphate.

In a case where emulsion polymerization is employed as the method of preparing the diene-based rubber and the (meth)acrylate-based rubber and/or as the method of preparing the graft part, a pyrolytic initiator can be used. It is possible to use, as the pyrolytic initiator, a known initiator such as (a) 2,2′-azobisisobutyronitrile, and (b) peroxides such as organic peroxides and inorganic peroxides, for example. Examples of the organic peroxide include t-butylperoxy isopropyl carbonate, paramenthane hydroperoxide, cumene hydroperoxide, dicumyl peroxide, t-butyl hydroperoxide, di-t-butyl peroxide, and t-hexyl peroxide. Examples of the inorganic peroxide include hydrogen peroxide, potassium persulfate, and ammonium persulfate.

In a case where emulsion polymerization is employed as the method of preparing the diene-based rubber and the (meth)acrylate-based rubber and/or as the method of preparing the graft part, a redox initiator can also be used. The redox initiator is an initiator which contains a combination of (a) a peroxide such as an organic peroxide and/or an inorganic peroxide and (b) a reducing agent such as a transition metal salt (such as iron (II) sulfate), sodium formaldehyde sulfoxylate and/or glucose. Further, for example, as necessary, a chelating agent such as disodium ethylenediaminetetraacetate, and/or, as necessary, a phosphorus-containing compound such as sodium pyrophosphate may be used in combination.

Using the redox initiator makes it possible to (i) carry out polymerization even at a low temperature at which pyrolysis of the peroxide substantially does not occur and (ii) select a polymerization temperature from a wide range of temperatures. Thus, using the redox initiator is preferable. Out of redox initiators, redox initiators in which organic peroxides such as cumene hydroperoxide, dicumyl peroxide, paramenthane hydroperoxide, and t-butyl hydroperoxide are used as peroxides are preferable. The amount of the initiator used can be within a known range. In a case where the redox initiator is used, the amounts of, for example, the reducing agent used, the transition metal salt used, and the chelating agent used can be within known ranges.

In a case where a polyfunctional monomer is used in the preparation of the elastic body and/or the graft part, a known chain transfer agent can be used in an amount within a known range. By using the chain transfer agent, it is possible to easily adjust the molecular weight and/or the degree of crosslinking of the resulting elastic body, the resulting graft part, or the resulting surface-crosslinked polymer.

In the production of the fine polymer particles (A), a surfactant can be further used, in addition to the above-described components. The type and the amount of the surfactant used are set within known ranges.

In the production of the fine polymer particles (A), conditions of polymerization such as polymerization temperature, pressure, and deoxygenation can be, as appropriate, conditions within known numerical ranges.

### (2-2. Resin (B))

The present stress reducing agent may further contain a resin (B), in addition to the fine polymer particles (A). By containing the resin (B), the present stress reducing agent has an advantage of achieving more excellent dispersibility of the fine polymer particles (A) in the matrix resin.

The resin (B) may be, for example, a thermosetting resin, a thermoplastic resin, or a combination of a thermosetting resin and a thermoplastic resin.

### (2-2-1. Thermosetting Resin)

The thermosetting resin in the resin (B) may include, but not particularly limited to, at least one type selected from the group consisting of: resins each containing a polymer obtained by polymerization of an ethylenically unsaturated monomer; epoxy resins; phenolic resins; polyol resins; and amino-formaldehyde resins. Examples of the thermosetting resin in the resin (B) also include resins each containing a polymer obtained by polymerization of an aromatic polyester raw material. In the resin (B), the thermosetting resins may be used alone or in combination of two or more thereof.

### (Epoxy Resins)

The epoxy resins are not limited to any particular ones, provided that the epoxy resins each have at least one epoxy group in its molecule.

Specific examples of the epoxy resins include bisphenol A epoxy resin, bisphenol F epoxy resin, bisphenol AD epoxy resin, bisphenol S epoxy resin, glycidyl ester type epoxy resin, glycidyl amine type epoxy resin, novolac type epoxy resin, glycidyl ether epoxy resin of bisphenol A propylene oxide adduct, hydrogenated bisphenol A (or F) epoxy resin, fluorinated epoxy resin, rubber-modified epoxy resin containing polybutadiene or NBR, flame-resistant epoxy resin such as glycidyl ether of tetrabromo bisphenol A, p-oxybenzoic acid glycidyl ether ester type epoxy resin, m-aminophenol type epoxy resin, diaminodiphenylmethane-based epoxy resin, urethane-modified epoxy resin containing urethane bond, various types of alicyclic epoxy resin, glycidyl ether of a polyhydric alcohol, hydantoin-type epoxy resin, epoxidized unsaturated polymer such as petroleum resin, and amino-containing glycidyl ether resin. Examples of the polyhydric alcohol include N,N-diglycidyl aniline, N,N-diglycidyl-o-toluidine, triglycidyl isocyanurate, polyalkylene glycol diglycidyl ether, and glycerin. Other examples of the epoxy resins include an epoxy compound obtained by causing an addition reaction between one of the above epoxy resins and e.g. a bisphenol A (or F) or a polybasic acid. The epoxy resins are not limited to these examples, and a generally used epoxy resin can be used. These epoxy resins may be used alone or in combination of two or more thereof.

Out of these epoxy resins, epoxy resins each of which has at least two epoxy groups in one molecule are preferable in that, e.g., such resins have high reactivity during curing of the resin composition and make it easy for an obtained cured product to create a three-dimensional mesh. In addition, out of the epoxy resins each of which has at least two epoxy groups in one molecule, epoxy resins each of which contains a bisphenol type epoxy resin as a main component are preferable, because they are economical and easily available.

### (2-2-2. Thermoplastic Resin)

Examples of the thermoplastic resin in the resin (B) include acrylic-based polymers, vinyl-based copolymers, polycarbonate, polyamides, polyesters, polyphenylene ether, polyurethane, and polyvinyl acetate. These may be used alone or in combination of two or more thereof.

The resin (B) may be the same resin (i.e., a resin having the same composition) as or a different resin from the matrix resin (described later) with which the stress reducing agent is to be mixed. It is preferable that the matrix resin and the resin (B) do not undergo phase separation in the resin composition. The resin (B) may be a resin compatible with the matrix resin.

In a case where the resin (B) is the same resin as the matrix resin (described later) with which the stress reducing agent is to be mixed, there is an advantage that the resin (B) does not exert influence on the various physical properties of a resin composition which contains the resulting stress reducing agent or a cured product.

For example, the following description will assume a case where the resin (B) is of the same type as the matrix resin. In this case, it is not possible to distinguish between the matrix resin and the resin (B) in the resin composition which contains the resulting stress reducing agent. Therefore, the resin composition which contains the resulting stress reducing agent appears to have only the resin (B) or only the matrix resin in addition to the fine polymer particles (A). Next, the following description will assume a case where the resin (B) is of a different type from the matrix resin. In this case, it is possible to distinguish between the matrix resin and the resin (B) in the resin composition which contains the resulting stress reducing agent. In this case, the ultimately obtained resin composition containing the stress reducing agent can contain the resin (B) as a resin other than the matrix resin, in addition to the fine polymer particles (A).

### (2-2-3. Others)

In the present specification, fats and oils as well as fatty acid esters are also included in the resin (B). Examples of the fats and oils which can be suitably used as the resin (B) include epoxidized fats and oils such as epoxidized soybean oil and epoxidized linseed oil. Commercially available epoxidized soybean oil can also be used, and examples thereof include ADK CIZER O-130P manufactured by ADEKA Co., Ltd. Examples of the fatty acid esters which can be suitably used as the resin (B) include epoxidized fatty acid esters such as epoxidized fatty acid butyl, epoxidized fatty acid 2-ethylhexyl, epoxidized fatty acid octyl ester, and epoxidized fatty acid alkyl ester.

The epoxidized fats and oils and the epoxidized fatty acid esters are sometimes referred to as epoxy-based plasticizers. That is, in the present specification, epoxy-based plasticizers are also included in the resin (B). Examples of the epoxy-based plasticizers, other than the epoxidized fats and oils and the epoxidized fatty acid esters, include diepoxystearyl epoxyhexahydrophthalate and epoxyhexahydro di(2-ethylhexyl)phthalate.

The above-described thermosetting resins, thermoplastic resins, mixtures of the thermosetting resins and the thermoplastic resins, fats and oils, and fatty acid esters can be each used in admixture with an antioxidant. In the present specification, the antioxidant is regarded as part of the resin (B), as long as the antioxidant is used in admixture with each of the above-described substances. In a case where only the antioxidant is used, the antioxidant is not regarded as the resin (B). The following description will discuss a case where only an antioxidant is used instead of the resin (B). The antioxidant is a component which does not contribute to crosslinking. Therefore, in a case where the obtained stress reducing agent is mixed with the matrix resin, a product which is ultimately obtained (i.e., an end product; e.g., a cured product, when the matrix resin is a thermosetting resin) tends to have inferior physical properties. For example, the end product may have lower Tg or inferior impact resistance.

The antioxidant is not limited to any particular one. Examples of the antioxidant include (a) primary antioxidants such as phenol-based antioxidants, amine-based antioxidants, lactone-based antioxidants, and hydroxylamine-based antioxidants and (b) secondary antioxidants such as sulfur-based antioxidants and phosphorus-based antioxidants.

The antioxidant can be other conventionally known substance. Examples of such an antioxidant include various substances described in, for example, “Sanka Boshizai Handobukku (Antioxidant Handbook)” published by Taiseisha (the date of publication of the first edition: Oct. 25, 1976), “Kobunshitenkazai handobukku (Polymeric additive Handbook)” published by CMC Publishing Co., Ltd. (the author and editor: HARUNA, Toru, the date of publication of the first edition: Nov. 7, 2010), and the like.

The resin (B) may be at least one selected from the group consisting of the thermosetting resins, mixtures of the thermosetting resins and the antioxidants, the thermoplastic resins, mixtures of the thermoplastic resins and the antioxidants, the fats and oils, mixtures of the fats and oils and the antioxidants, the fatty acid esters, mixtures of the fatty acid esters and the antioxidants, epoxy curing agents, and mixtures of the epoxy curing agents and the antioxidants, at least one selected from the group consisting of epoxy resins, acrylic polymers, mixtures of the epoxy resins and the antioxidants, mixtures of the acrylic polymers and the antioxidants, and mixtures of the epoxy-based plasticizers and the antioxidants, at least one selected from the group consisting of the mixtures of the epoxy resins and the antioxidants, the mixtures of the acrylic polymers and the antioxidants, and the mixtures of the epoxy-based plasticizers and the antioxidants, or any of the mixtures of the epoxy-based plasticizers and the antioxidants. According to the above configuration, the resin composition which contains the resulting stress reducing agent has advantages in that (a) it is possible to provide the cured product which has excellent heat resistance, and (b) it is possible to improve the dispersibility of the fine polymer particles (A) in the matrix resin.

### (2-2-4. Physical Properties of Resin (B))

The resin (B) is not particularly limited in its properties, provided that the resin (B) is a liquid having a viscosity of 100 mPa·s to 1,000,000 mPa·s at 25° C., a semisolid, or a solid. Note that, in the present specification, the wording “the resin (B) has a viscosity of 100 mPa·s to 1,000,000 mPa·s at 25° C.” means that “the resin (B) which is at 25° C. has a viscosity of 100 mPa·s to 1,000,000 mPa·s”.

In a case where the resin (B) is a liquid, the viscosity of the resin (B) may be not more than 750,000 mPa·s at 25° C. According to the above configuration, the stress reducing agent has an advantage of having excellent flowability.

The viscosity of the resin (B) may be not less than 200 mPa·s, or not less than 300 mPa·s, at 25° C. With this configuration, the resin (B) is not impregnated into the fine polymer particles (A) but can enter gaps between the plurality of fine polymer particles (A) and remain in the vicinity of the surfaces of the fine polymer particles (A). Thus, the fine polymer particles (A) are prevented, by the resin (B), from fusing together.

The viscosity of the resin (B) may be 100 mPa·s to 750,000 mPa·s, 100 mPa·s to 700,000 mPa·s, 100 mPa·s to 350,000 mPa·s, 100 mPa·s to 300,000 mPa·s, 100 mPa·s to 50,000 mPa·s, 100 mPa·s to 30,000 mPa·s, or 100 mPa·s to 15,000 mPa s, at 25° C.

In a case where the resin (B) is a semisolid at 25° C., it can be said that the resin (B) is a semiliquid at 25° C., and it can be said that the resin (B) has a viscosity of more than 1,000,000 mPa·s at 25° C. In a case where the resin (B) is a semisolid or a solid at 25° C., the resin composition which contains the resulting stress reducing agent has an advantage of being less sticky and being easy to handle.

The amount of the resin (B) contained in the stress reducing agent is as follows: the fine polymer particles (A) are contained in an amount of 50% by weight to 99% by weight and the resin (B) is contained in an amount of 1% by weight to 50% by weight, where 100% by weight represents the total amount of the fine polymer particles (A) and the resin (B). The amount of the resin (B) can be set as appropriate according to the type of the resin (B), the physical properties (solid, semisolid, liquid, viscosity, or the like) of the resin (B), and the like, provided that the amount of the resin (B) is within the above numerical range and that a stress reducing agent can be obtained. In a case where the resin (B) is liquid at 25° C. and the amount of the resin (B) contained in the stress reducing agent is large, there may be cases where a stress reducing agent is not obtained. In a case where the resin (B) is liquid at 25° C. and the amount of the resin (B) contained in the stress reducing agent is large, the flowability (thinness) of the stress reducing agent may decrease.

The following description discusses the amount of the resin (B) contained in the stress reducing agent, from the viewpoint of achieving excellent anti-blocking property. In a case where 100% by weight represents the total amount of the fine polymer particles (A) and the resin (B), it is more preferable that the fine polymer particles (A) be contained in an amount of 55% by weight to 99% by weight and the resin (B) be contained in an amount of 1% by weight to 45% by weight, more preferable that the fine polymer particles (A) be contained in an amount of 60% by weight to 99% by weight and the resin (B) be contained in an amount of 1% by weight to 40% by weight, more preferable that the fine polymer particles (A) be contained in an amount of 65% by weight to 99% by weight and the resin (B) be contained in an amount of 1% by weight to 35% by weight, more preferable that the fine polymer particles (A) be contained in an amount of 70% by weight to 99% by weight and the resin (B) be contained in an amount of 1% by weight to 30% by weight, more preferable that the fine polymer particles (A) be contained in an amount of 75% by weight to 99% by weight and the resin (B) be contained in an amount of 1% by weight to 25% by weight, more preferable that the fine polymer particles (A) be contained in an amount of 80% by weight to 99% by weight and the resin (B) be contained in an amount of 1% by weight to 20% by weight, even more preferable that the fine polymer particles (A) be contained in an amount of 85% by weight to 99% by weight and the resin (B) be contained in an amount of 1% by weight to 15% by weight, even more preferable that the fine polymer particles (A) be contained in an amount of 90% by weight to 99% by weight and the resin (B) be contained in an amount of 1% by weight to 10% by weight, and particularly preferable that the fine polymer particles (A) be contained in an amount of 95% by weight to 99% by weight and the resin (B) be contained in an amount of 1% by weight to 5% by weight.

The following description discusses the amount of the resin (B) contained in the stress reducing agent, from the viewpoint of achieving favorable dispersibility of the fine polymer particles (A) in the matrix resin. It is preferable that, in a case where 100% by weight represents the total amount of the fine polymer particles (A) and the resin (B), the fine polymer particles (A) be contained in an amount of 50% by weight to 97% by weight and the resin (B) be contained in an amount of 3% by weight to 50% by weight, more preferable that the fine polymer particles (A) be contained in an amount of 50% by weight to 95% by weight and the resin (B) be contained in an amount of 5% by weight to 50% by weight, more preferable that the fine polymer particles (A) be contained in an amount of 50% by weight to 92% by weight and the resin (B) be contained in an amount of 8% by weight to 50% by weight, more preferable that the fine polymer particles (A) be contained in an amount of 50% by weight to 90% by weight and the resin (B) be contained in an amount of 10% by weight to 50% by weight, more preferable that the fine polymer particles (A) be contained in an amount of 50% by weight to 87% by weight and the resin (B) be contained in an amount of 13% by weight to 50% by weight, more preferable that the fine polymer particles (A) be contained in an amount of 50% by weight to 85% by weight and the resin (B) be contained in an amount of 15% by weight to 50% by weight, even more preferable that the fine polymer particles (A) be contained in an amount of 50% by weight to 82% by weight and the resin (B) be contained in an amount of 18% by weight to 50% by weight, even more preferable that the fine polymer particles (A) be contained in an amount of 50% by weight to 80% by weight and the resin (B) be contained in an amount of 20% by weight to 50% by weight, and particularly preferable that the fine polymer particles (A) be contained in an amount of 60% by weight to 80% by weight and the resin (B) be contained in an amount of 20% by weight to 40% by weight.

### (2-3. Anti-Blocking Agent)

The stress reducing agent may further contain an anti-blocking agent. With this configuration, the resulting stress reducing agent (a) has an excellent anti-blocking property, and (b) achieves excellent dispersibility of the fine polymer particles (A) in the matrix resin.

The anti-blocking agent is not particularly limited, provided that the effect of one or more embodiments of the present invention is obtained. Examples of the anti-blocking agent include: anti-blocking agents composed of inorganic fine particles, such as fine particles of silicon dioxide, titanium oxide, aluminum oxide, zirconium oxide, aluminum silicate, diatomaceous earth, zeolite, kaolin, talc, calcium carbonate, calcium phosphate, barium sulfate, or magnesium hydrosilicate; anti-blocking agents composed of organic fine particles; and fat-based and/or oil-based anti-blocking agents such as polyethylene wax, higher fatty acid amides, metal soap, and silicone oil. Out of such anti-blocking agents, anti-blocking agents composed of fine particles are preferred, anti-blocking agents composed of organic fine particles are more preferred. The anti-blocking agent composed of organic fine particles may be an anti-blocking agent composed of organic fine particles of a polymer that contains, as one or more structural units, one or more structural units derived from at least one type of monomer selected from aromatic vinyl-based monomers, vinyl cyanide monomers, and (meth)acrylate monomers.

An anti-blocking agent composed of fine particles, in general, is in the form of a dispersion composed of the fine particles and a medium in which the particles are dispersed or is in the form of a colloid. The fine particles in the anti-blocking agent may have a volume-average particle size (Mv) of usually not greater than 10 μm, or 0.05 μm to 10.00 μm. The amount of the anti-blocking agent with respect to the total weight (100% by weight) of the stress reducing agent may be 0.01% by weight to 5.00% by weight, or 0.50% by weight to 3.00% by weight.

### (2-4. Other Optional Components)

The stress reducing agent may contain, as necessary, other optional component(s) other than the above-described components. Examples of the other optional components include various kinds of components which will be described later in the section under (4-4. Other optional components) described later.

The anti-blocking agent and other optional component(s) can be added as appropriate during any step in a method of producing the stress reducing agent. For example, the anti-blocking agent and other optional component(s) can be added to an aqueous suspension (aqueous latex) before or after flocculation of the fine polymer particles (A) or the fine polymer particles (A) and resin (B). Alternatively, the anti-blocking agent and other optional component(s) can be added to a stress reducing agent containing the fine polymer particles (A), the resin (B), or the fine polymer particles (A) and resin (B).

### 3. Method of Producing Stress Reducing Agent

In one or more embodiments of the present invention, a method of producing a stress reducing agent is not particularly limited. The following will describe an example of a method of producing a stress reducing agent by taking, as an example, a case in which the stress reducing agent contains the fine polymer particles (A) and the resin (B). Note that, in a case where the resin (B) is not used in the following production method, a stress reducing agent containing the fine polymer particles (A) and not containing the resin (B) can be obtained.

In one or more embodiments of the present invention, a method of producing a stress reducing agent includes: a resin (B) addition step of adding the resin (B) to an aqueous latex containing the fine polymer particles (A); an agglutination step of preparing, with use of the aqueous latex thus obtained, an agglutinate that contains the fine polymer particles (A) and the resin (B); and a collection step of collecting the agglutinate. In the present specification, the terms “agglutinate”, “coagulate”, and “flocculate” have the same meaning and may be used interchangeably.

The resin (B) addition step is a step of obtaining an aqueous latex that contains the fine polymer particles (A) and the resin (B). It can also be said that the resin (B) addition step is a step of mixing the fine polymer particles (A) and the resin (B). A specific method of adding the resin (B) to the aqueous latex that contains the fine polymer particles (A) is not particularly limited, and is, for example, a method involving directly adding the resin (B) to the aqueous latex that contains the fine polymer particles (A), a method involving adding the resin (B) in the form of aqueous emulsion to the aqueous latex that contains the fine polymer particles (A), a method involving adding the resin (B) in the form of a solution to the aqueous latex that contains the fine polymer particles (A), or the like method. In the step of adding the resin (B), it is preferable to add the resin (B) in the form of aqueous emulsion to the aqueous latex that contains the fine polymer particles (A).

The agglutination step is a step for allowing the fine polymer particles (A) and the resin (B) in the aqueous latex to agglutinate. In the agglutination step, it is possible to obtain an agglutinate that contains the fine polymer particles (A) and the resin (B). A method of allowing the fine polymer particles (A) and the resin (B) to agglutinate is not particularly limited, and is, for example, a method using a solvent, a method using an agglutinant (also referred to as coagulant or flocculant), a method involving spraying the aqueous latex that contains the fine polymer particles (A) and the resin (B), or the like method.

The agglutination step may include a step of preparing an agglutinate that contains the fine polymer particles (A) and the resin (B) with use of an agglutinant. This configuration does not necessitate using a solvent and therefore makes it possible to obtain a powdery and/or granular material for thermosetting resin that places less environmental load. Furthermore, the above configuration does not necessitate using any special equipment for spraying, and therefore makes it possible to easily obtain a powdery and/or granular material for thermosetting resin.

The collection step is a step of obtaining the agglutinate that contains the fine polymer particles (A) and the resin (B) by removing water from the aqueous latex. The collection step can be rephrased as a step of separating the aqueous latex into (i) the agglutinate that contains the fine polymer particles (A) and the resin (B) and (ii) a water component. Note that the water component is a mixture that contains water as a main component and contains an emulsifying agent, non-agglutinated fine polymer particles (A), a resin (B), and the like. A method of collecting the agglutinate that contains the fine polymer particles (A) and the resin (B) is not particularly limited, and is, for example, filtration, centrifugation, or the like method.

The agglutinate obtained through the resin (B) addition step, the agglutination step, and the collection step described above can be used as a stress reducing agent.

In one or more embodiments of the present invention, the method of producing a stress reducing agent may further include a washing step.

The washing step is a step of washing the agglutinate that contains the fine polymer particles (A) and the resin (B) obtained in the collection step. By washing the agglutinate, it is possible to obtain a powdery and/or granular material for thermosetting resin that contains small amounts of contaminants and the like. In the washing step, the agglutinate may be washed with water, or with ion exchanged water or pure water.

The washing step only needs to be a step of washing the agglutinate, and a specific method of the washing step is not particularly limited. Examples of the specific method of the washing step include: a method involving mixing the agglutinate with water and stirring the mixture by a stirrer; a method involving kneading the agglutinate and water with use of a kneader; a method involving mixing the agglutinate with water with use of a planetary centrifugal mixer; a method involving spraying water onto the agglutinate; and a method involving carrying out cake washing with use of a press filter. Examples of the kneader include various types of kneaders such as batch type kneaders, continuous type kneaders, extrusion type kneaders, and extruders.

An object to be removed by washing is intended to mean impurities contained in the agglutinate in general, and is not particularly limited. Examples of the object include: contaminants derived from an emulsifying agent (e.g., phosphorus-based emulsifying agent, sulfonic acid-based emulsifying agent); and, in a case where the agglutinant described later is used, contaminants derived from the agglutinant.

Examples of the emulsifying agent include: (a) anionic emulsifying agents such as various acids as listed below, alkali metal salts of the acids, and ammonium salts of the acids; (b) nonionic emulsifying agents such as alkyl-substituted polyethylene glycols and aryl-substituted polyethylene glycols; and (c) emulsifying agents such as polyvinyl alcohol, alkyl-substituted celluloses, polyvinylpyrrolidone, and polyacrylic acid derivatives. Examples of the acids include: (a1) alkyl sulfonic acids (typified by, for example, dioctyl sulfosuccinic acid and dodecylbenzenesulfonic acid) and aryl sulfonic acids, and alkyl ether sulfonic acids and aryl ether sulfonic acids; (a2) alkyl sulfates (typified by dodecyl sulfate) and aryl sulfates, and alkyl ether sulfates and aryl ether sulfates; (a3) alkyl-substituted phosphoric acids and aryl-substituted phosphoric acids, and alkyl ether-substituted phosphoric acids and aryl ether-substituted phosphoric acids; (a4) N-alkyl sarcosine acids (typified by dodecyl sarcosine acid) and aryl sarcosine acids; and (a5) alkyl carboxylic acids (typified by, for example, oleic acid and stearic acid) and aryl carboxylic acids, and alkyl ether carboxylic acids and aryl ether carboxylic acids. Here, the anionic emulsifying agents formed from the acids described in (a1) and (a2) above are referred to as sulfur-based emulsifying agents, the anionic emulsifying agents formed from the acids described in (a3) above are referred to as phosphorus-based emulsifying agents, the anionic emulsifying agents formed from the acids described in (a4) above are referred to as sarcosine acid-based emulsifying agents, and the anionic emulsifying agents formed from the acids described in (a5) above are referred to as carboxylic acid-based emulsifying agents. These emulsifying agents may be used alone or in combination of two or more thereof.

In one or more embodiments of the present invention, the method of producing a stress reducing agent may further include a drying step. By drying the stress reducing agent obtained by the above-described method, it is possible to obtain a stress reducing agent that is a powdery and/or granular material.

The drying step is a step of drying the agglutinate, obtained in the collection step or the washing step, containing the fine polymer particles (A) and the resin (B) to obtain a powdery and/or granular material. A method of drying the agglutinate is not particularly limited, and examples thereof include a method involving drying the agglutinate with use of a dryer, a method involving introducing the agglutinate in a container and raising the temperature and reducing the pressure inside the container, and a method involving introducing the agglutinate in a container and subjecting a dry gas and the agglutinate to countercurrent contact within the container.

### 4. Resin Composition

One or more embodiments of the present invention also encompass a resin composition which contains the foregoing stress reducing agent and a matrix resin. A “resin composition in accordance with one or more embodiments of the present invention” may be hereinafter referred to as “present resin composition”. The present stress reducing agent, by being added to the matrix resin, can decrease the elastic modulus of the matrix resin and reduce the deterioration of the linear expansion coefficient.

### (4-1. Matrix Resin)

The matrix resin is not particularly limited, and is, for example, a thermosetting resin, a thermoplastic resin, or any combination of a thermosetting resin and a thermoplastic resin.

Above all, from the viewpoint of suitably exhibiting the function of the present stress reducing agent, the matrix resin may be a thermosetting resin such as an epoxy resin, a phenol resin, a polyimide resin, and an oxetane resin, or a thermoplastic resin such as a polycarbonate resin. Alternatively, the thermosetting resin and the thermoplastic resin may be the same as the thermosetting resin and the thermoplastic resin described in the section under (2-2. Resin (B)) above.

The matrix resin may be an epoxy-based resin. The epoxy-based resin may be the same as the epoxy-based resin described in the section under (2-2. Resin (B)) above. The epoxy-based resin may be used alone. Alternatively, the epoxy-based resin and at least one matrix resin other than the epoxy-based resin may be used in combination.

### (4-2. Physical Properties of Matrix Resin)

The matrix resin is not particularly limited in terms of the properties thereof. The matrix resin may have a viscosity of 100 mPa·s to 1,000,000 mPa·s at 25° C. The viscosity of the matrix resin may be not more than 50,000 mPa·s, not more than 30,000 mPa·s, or not more than 15,000 mPa·s, at 25° C. According to the above configuration, the matrix resin has an advantage of having excellent flowability. It can also be said that the matrix resin having a viscosity of 100 mPa·s to 1,000,000 mPa·s at 25° C. is a liquid.

As the flowability of the matrix resin becomes greater, in other words, as the viscosity of the matrix resin becomes lower, it becomes more difficult to disperse, in the matrix resin, the fine polymer particles (A) in the form of primary particles. Conventionally, it has been extremely difficult to disperse, in the matrix resin having a viscosity of not more than 1,000,000 mPa·s at 25° C., the fine polymer particles (A) in the form of the primary particles. However, the resin composition in accordance with one or more embodiments of the present invention has an advantage in that the fine polymer particles (A) having the above configuration are favorably dispersed in the matrix resin having a viscosity of not more than 1,000,000 mPa·s at 25° C.

Further, the viscosity of the matrix resin may be not less than 100 mPa·s, not less than 500 mPa·s, not less than 1000 mPa·s, or not less than 1500 mPa·s at 25° C., because such a viscosity allows the matrix resin to get between the fine polymer particles (A) and thereby allows prevention of fusion between the fine polymer particles (A).

The viscosity of the matrix resin may be 100 mPa·s to 750,000 mPa·s, 100 mPa·s to 700,000 mPa·s, 100 mPa·s to 350,000 mPa·s, 100 mPa·s to 300,000 mPa·s, 100 mPa·s to 50,000 mPa·s, 100 mPa·s to 30,000 mPa·s, or 100 mPa·s to 15,000 mPa s, at 25° C.

The matrix resin may have a viscosity of more than 1,000,000 mPa·s. The matrix resin may be a semisolid (semiliquid) or may be alternatively a solid. In a case where the matrix resin has a viscosity of more than 1,000,000 mPa·s, the resin composition which contains the resulting powdery and/or granular material has an advantage of being less sticky and being easy to handle.

The matrix resin may have an endothermic peak at not higher than 25° C., or not higher than 0° C., in its differential scanning calorimetry (DSC) thermogram. According to the above configuration, the matrix resin has an advantage of having excellent flowability.

### (4-3. Blending Ratio Between Stress Reducing Agent and Matrix Resin, Etc.)

The blending ratio between the stress reducing agent and the matrix resin is as follows. In a case where the total amount of the stress reducing agent and the matrix resin is regarded as 100% by weight, it is usually preferable that the amount of the stress reducing agent be 0.5% by weight to 50% by weight and the amount of the matrix resin be 50% by weight to 99.5% by weight, it is more preferable that the amount of the stress reducing agent be 1% by weight to 40% by weight and the amount of the matrix resin be 60% by weight to 99% by weight, it is more preferable that the amount of the stress reducing agent be 1% by weight to 25% by weight and the amount of the matrix resin be 75% by weight to 99% by weight, and it is particularly preferable that the amount of the stress reducing agent be 2.5% by weight to 20% by weight and the amount of the matrix resin be 80% by weight to 97.5% by weight.

The blending ratio of the stress reducing agent and the matrix resin can be set as appropriate in accordance with, for example, (a) the contained amount of components other than the fine polymer particles (A) and the water content in the powdery and/or granular material and (b) a method of mixing the stress reducing agent with the matrix resin, for the purpose of obtaining an intended proportion of the amounts of the fine polymer particles (A) and the matrix resin contained in the obtained resin composition.

The content ratio between the fine polymer particles (A) and the matrix resin in the resin composition is as follows. In a case where the total amount of the fine polymer particles (A) and the matrix resin is regarded as 100% by weight, it is usually preferable that the amount of the fine polymer particles (A) be 0.5% by weight to 50% by weight and the amount of the matrix resin be 50% by weight to 99.5% by weight, it is more preferable that the amount of the fine polymer particles (A) be 1% by weight to 40% by weight and the amount of the matrix resin be 60% by weight to 99% by weight, it is more preferable that the amount of the fine polymer particles (A) be 1% by weight to 25% by weight and the amount of the matrix resin be 75% by weight to 99% by weight, and it is particularly preferable that the amount of the fine polymer particles (A) be 2.5% by weight to 20% by weight and the amount of the matrix resin be 80% by weight to 97.5% by weight.

In a case where the matrix resin is an epoxy resin, the state of the matrix resin is not particularly limited, provided that the matrix resin is flowable when mixed with the stress reducing agent. The matrix resin may be in its solid state at room temperature. In terms of achieving workability, the matrix resin may be in its liquid state.

Typically, the temperature at which the stress reducing agent and the matrix resin are mixed together is set to a temperature at which the matrix resin is flowable. In regard to the temperature, if the resin (B) in the powdery and/or granular material is flowable at a temperature at which the matrix resin is flowable, the resin (B) and the matrix resin can be easily mixed uniformly.

In a case where the present resin composition contains a thermosetting resin as the matrix resin, it is possible to obtain a cured product by curing the resin composition. In a case where the present resin composition contains a thermoplastic resin as the matrix resin, it is possible to obtain a molded product by molding the resin composition. The cured product obtained by curing the present resin composition and the molded product obtained by molding the present resin composition are also encompassed in one or more embodiments of the present invention.

The present resin composition may further contain a known thermosetting resin other than the matrix resin, and may further contain a known thermoplastic resin.

### (4-4. Other Optional Components)

The present resin composition may contain, as necessary, other optional component(s) which is different from the above-described components. The present resin composition may contain silica as an inorganic filler. The silica may be used alone. Alternatively, the silica may be used in combination with at least one other optional component other than silica. Examples of the other optional component include: curing agents; coloring agents such as pigments and colorants; extenders; pigment dispersing agents; ultraviolet ray absorbing agents; the foregoing antioxidants; heat stabilizers (antigelling agents); plasticizing agents; leveling agents; defoaming agents; silane coupling agents; antistatic agents; flame retardants; lubricants; viscosity reducers; viscosity modifiers; thixotropy-imparting agents; shrinkage reducing agents; inorganic filler; organic filler; thermoplastic resins; desiccants; dispersion agents; thermal conductivity improving agents; water binders; anti-sag agents; antiflooding agents; anti-settling agents; coating film wear regulating agents; surface control agents; monobasic organic acids; camphor; and castor oil.

### (4-5. Method for Producing Resin Composition)

A method for producing a resin composition in accordance with one or more embodiments of the present invention is a resin composition production method including a step of mixing the stress reducing agent containing the fine polymer particles (A), a thermosetting resin, and an inorganic filler. The stress reducing agent containing the fine polymer particles (A) can be produced by the production method which has been described in the section under [3. Method of producing stress reducing agent] described earlier.

The method for producing the present resin composition is not particularly limited, provided that the method is a production method which includes a step of mixing a stress reducing agent containing fine polymer particles (A), a thermosetting resin, and an inorganic filler, and may include, for example, a method of, after mixing the stress reducing agent and the thermosetting resin, adding, to a resulting mixture, the inorganic filler and, if necessary, the aforementioned other optional component (s), and then mixing them with a mixer or the like. Note that the order in which the stress reducing agent, the thermosetting resin, the inorganic filler, and the other optional component(s) are added is not limited to the above-described order, and may be any order.

A method for producing a resin composition in accordance with one or more embodiments of the present invention may be a resin composition production method including a step of mixing the stress reducing agent containing the fine polymer particles (A), an epoxy-based resin, and silica. Even in the production method including the step of mixing the stress reducing agent containing the fine polymer particles (A), an epoxy-based resin, and silica, the order in which the stress reducing agent, the epoxy-based resin, the silica, and the other optional component(s) are added may be any order. The production method includes, for example, a method of, after mixing the stress reducing agent and the epoxy-based resin, adding, to a resulting mixture, the silica and, if necessary, the aforementioned other optional component(s), and then mixing them with a mixer or the like.

### (5. Sealing Material)

A sealing material in accordance with one or more embodiments of the present invention is obtained with use of the above-described stress reducing agent or resin composition. The sealing material in accordance with one or more embodiments of the present invention has the above configuration, and therefore has an advantage of having excellent toughness and excellent impact resistance.

The sealing material in accordance with one or more embodiments of the present invention is also simply referred to as present sealing material.

Purposes of use of the present sealing material are not particularly limited. Examples of the purposes of use include a sealing material for use in electrical devices such as semiconductors and in power devices.

The present sealing material can be produced with use of the stress reducing agent or resin composition. A method of producing the present sealing material is not limited to any particular one, and a known method can be employed.

### SUMMARY

One or more embodiments of the present invention encompass the following configurations.

<1> A stress reducing agent containing fine polymer particles (A), wherein: the fine polymer particles (A) contain a rubber-containing graft copolymer that includes an elastic body and a graft part grafted to the elastic body; a proportion of the elastic body contained in the fine polymer particles (A) is more than 70% by weight and not more than 97% by weight, with respect to 100% by weight of the fine polymer particles (A); the elastic body contains an organosiloxane-based rubber; the graft part contains an epoxy group-containing structural unit; the epoxy group-containing structural unit in the graft part is contained in an amount of 0.5% by weight to 4.0% by weight with respect to 100% by weight of the rubber-containing graft copolymer; and the stress reducing agent is a powdery and/or granular material.

<2> The stress reducing agent described in <1>, wherein the epoxy group-containing structural unit in the graft part is contained in an amount of 3.3% by weight to 26.7% by weight with respect to 100% by weight of the graft part in the rubber-containing graft copolymer.

<3> A stress reducing agent containing fine polymer particles (A), wherein: the fine polymer particles (A) contain a rubber-containing graft copolymer that includes an elastic body and a graft part grafted to the elastic body; a proportion of the elastic body contained in the fine polymer particles (A) is more than 70% by weight and not more than 97% by weight, with respect to 100% by weight of the fine polymer particles (A); the elastic body contains an organosiloxane-based rubber; the graft part contains an epoxy group-containing structural unit; the epoxy group-containing structural unit in the graft part is contained in an amount of 3.3% by weight to 26.7% by weight with respect to 100% by weight of the graft part in the rubber-containing graft copolymer; and the stress reducing agent is a powdery and/or granular material.

<4> The stress reducing agent described in any of <1> to <3>, wherein the epoxy group-containing structural unit in the graft part is a glycidyl methacrylate unit.

<5> The stress reducing agent described in any of <1> to <4>, further including a resin (B).

<6> A resin composition including: a stress reducing agent described in any of <1> to <5>; a thermosetting resin; and an inorganic filler.

<7> The resin composition described in any of <1> to <6>, wherein the thermosetting resin is an epoxy-based resin, and the inorganic filler is silica.

<8> A sealing material including a resin composition described in <6>.

<9> The sealing material including a resin composition described in <7>.

<10> A method for producing a resin composition, including a step of mixing a stress reducing agent containing fine polymer particles (A), a thermosetting resin, and an inorganic filler, wherein: the fine polymer particles (A) contain a rubber-containing graft copolymer that includes an elastic body and a graft part grafted to the elastic body; a proportion of the elastic body contained in the fine polymer particles (A) is more than 70% by weight and not more than 97% by weight, with respect to 100% by weight of the fine polymer particles (A); the elastic body contains an organosiloxane-based rubber; the graft part contains an epoxy group-containing structural unit; the epoxy group-containing structural unit in the graft part is contained in an amount of 0.5% by weight to 4.0% by weight with respect to 100% by weight of the rubber-containing graft copolymer; and the stress reducing agent is a powdery and/or granular material.

<11> The method described in <10>, wherein the epoxy group-containing structural unit in the graft part is contained in an amount of 3.3% by weight to 26.7% by weight with respect to 100% by weight of the graft part in the rubber-containing graft copolymer.

<12> A method for producing a resin composition, including a step of mixing a stress reducing agent containing fine polymer particles (A), a thermosetting resin, and an inorganic filler, wherein: the fine polymer particles (A) contain a rubber-containing graft copolymer that includes an elastic body and a graft part grafted to the elastic body; a proportion of the elastic body contained in the fine polymer particles (A) is more than 70% by weight and not more than 97% by weight, with respect to 100% by weight of the fine polymer particles (A); the elastic body contains an organosiloxane-based rubber; the graft part contains an epoxy group-containing structural unit; the epoxy group-containing structural unit in the graft part is contained in an amount of 3.3% by weight to 26.7% by weight with respect to 100% by weight of the graft part in the rubber-containing graft copolymer; and the stress reducing agent is a powdery and/or granular material.

<13> The method described in any of <10> to <12>, wherein the epoxy group-containing structural unit in the graft part is a glycidyl methacrylate unit.

<14> The method described in any of <10> to <13>, wherein the stress reducing agent further includes a resin (B).

<15> The method described in any of <10> to <14>, wherein the thermosetting resin is an epoxy-based resin, and the inorganic filler is silica.

### EXAMPLES

The following description will discuss one or more embodiments of the present invention in detail with reference to Examples and Comparative Examples. Note that one or more embodiments of the present invention are not limited to these examples. One or more embodiments of the present invention can be carried out while being altered as appropriate within the scope that is adaptable to the gist described before and later. One or more embodiments of the present invention also include, in their technical scope, one or more embodiments obtained by altering the one or more embodiments. Note that, in the following Examples and Comparative Examples, “parts” means “parts by weight”, and “%” means “% by weight”.

### <Component>

Components used in Production Examples, Examples, and Comparative Examples are as follows:
Fine polymer particles (A)

Fine polymer particles (A) obtained in Production Examples described below were used.
Resin (B)

(i) Epoxidized soybean oil (ADK CIZER O-130P manufactured by ADEKA CORPORATION) was used solely. Alternatively,

(ii) A mixture of 90 parts by weight of the epoxidized soybean oil and 10 weight of triethylene glycol bis[3-(3-t-butyl-4-hydroxy-5-methylphenyl)propionate](antioxidant) (Irganox 245, manufactured by BASF JAPAN LTD.) was used.
Matrix resin

Bisphenol A epoxy resin (JER 828 manufactured by Mitsubishi Chemical Corporation) was used.

### <Evaluation Methods>

First, the following description will discuss methods of evaluating resin compositions produced in Examples and Comparative Examples.

### (Measurement of Volume-Average Particle Size)

The volume-average particle sizes (Mv) of an elastic body (elastic core layer) and fine polymer particles (A) dispersed in an aqueous latex were measured with use of Nanotrac Wave II-EX150 (manufactured by MicrotracBEL Corp.). A test specimen used for measurement was prepared by diluting the aqueous latex in deionized water. When the measurement was made, the refractive index of water and the refractive indices of the elastic body and the fine polymer particles were inputted, the measurement time was set to 120 seconds, and the concentration of the test specimen was adjusted such that a load index fell within the range of 1 to 10.

(Dispersibility of Powdery and/or Granular Material in Matrix Resin)

Powdery and/or granular materials obtained in Examples and Comparative Examples were each prepared in an amount of 15 parts by weight (15 g), and bisphenol A epoxy resin, which was the matrix resin, was prepared in an amount of 85 parts by weight (85 g). The prepared powdery and/or granular material and the bisphenol A epoxy resin were introduced into a container having a capacity of 200 mL. The capacity of the container was approximately twice as large as the volume of the prepared powdery and/or granular material and bisphenol A epoxy resin. The powdery and/or granular material and the bisphenol A epoxy resin were mixed with use of a disper mixer (manufactured by PRIMIX Corporation) having a stirring blade with a blade diameter of 032 mm at a rotation speed of 3000 rpm, and thus a resin composition was obtained. A resin composition was placed on a grindometer (grind gage), the resin composition on the gauge was scraped with use of a metal scraper, and the state of dispersion was visually checked. The point on the scale of the grindometer, at which there were five to ten particles (which became apparent by the scraping) within a range 3 mm in width, was read, and a time until the scale indicated 0 μm was measured. The results are shown in Table 1.

### (Measurement of Physical Properties of Cured Product of Epoxy-Silica Formulation)

To 24.6 parts by weight of “JER 828” were added 47.1 parts by weight of “MH-700” (product name, manufactured by New Japan Chemical Co., Ltd.) as a curing agent, 0.471 parts by weight of 2-ethyl-4-methylimidazole as a curing accelerator, 50 parts by weight of “CMC-12 S” (product name, manufactured by Tatsumori Ltd.) as silica, 0.2 parts by weight of “BYK 1790” (product name, manufactured by BYK) as a defoaming agent, and 33.3 parts by weight of the resin composition (resin composition which was obtained in the section under (Dispersibility of powdery and/or granular material in matrix resin) described above and which was subjected to a test, using each of the powdery and/or granular materials obtained in Examples and Comparative Examples, of dispersibility of the powdery and/or granular material in the matrix resin). A resulting mixture was mixed at 2000 rpm for 60 minutes by a planetary centrifugal mixer to obtain an epoxy-silica formulation (resin composition). This formulation was poured into a mold frame and heated at 100° C. for 1 hour and at 150° C. for 3 hours to obtain a cured plate. The cured plate was cut, and a bending test was performed at an inter-fulcrum distance of 80 mm and at a test speed of 2 mm/min. In addition, the cured plate was cut, and a linear expansion coefficient (CTE) in a range of 100° C. to 130° C. was measured at a temperature rise rate of 10° C./min with use of TA7000 manufactured by Hitachi High-Tech Science Corporation.

### <1. Preparation of Aqueous Latex Containing Fine Polymer Particles (A)>

### Production Example 1-1; Preparation of Aqueous Latex (L-1) Containing Fine Polymer Particles (A)

Into a pressure-resistant polymerization apparatus were introduced 110 parts by weight of deionized water, 0.5 parts by weight of SDS, 100 parts by weight of octamethylcyclotetrasiloxane (D4), 2 parts by weight of tetraethoxysilane, and 2 parts by weight of γ-acryloyloxypropyldimethoxymethylsilane as a monomer M, and these materials were mixed. A resulting liquid mixture was stirred at 10000 rpm for 5 minutes with use of a homomixer to prepare an emulsion. The emulsion thus obtained was charged at a time into a five-neck glass vessel. The glass vessel here had a thermometer, a stirrer, a reflux condenser, a nitrogen inlet, and an inlet for monomer and emulsifying agent. While the materials thus introduced were stirred, (i) a 10% aqueous solution of dodecylbenzenesulfonic acid (DSA) in an amount corresponding to 1 part by weight of a solid content in the aqueous solution was added to the glass vessel, (ii) the temperature inside the glass vessel was then raised to 80° C. over about 40 minutes, and, after that, (iii) a resulting mixture was allowed to react at 80° C. for 6 hours. After that, the temperature inside the glass vessel was lowered to 25° C. After the temperature inside the glass vessel had reached 25° C., the mixture was left to stand inside the glass vessel for 20 hours. After that, the pH of a resulting reaction solution was adjusted to 6.8 with use of sodium hydroxide, and thereby the polymerization was ended. Through the above operations was obtained an aqueous latex (R-1) containing an elastic body containing an organosiloxane-based rubber as a main component. 99% or more of the monomer component had been polymerized. The volume-average particle size of the elastic body containing an organosiloxane-based rubber as a main component, contained in the obtained aqueous latex, was 280 nm.

Into a glass reaction vessel were introduced 180 parts by weight of the aqueous latex (R-1) of organosiloxane-based rubber (including 85 parts by weight of the elastic body containing polyorganosiloxane rubber as a main component) and 43 parts by weight of deionized water. The glass reaction vessel here had a thermometer, a stirrer, a reflux condenser, a nitrogen inlet, and a monomer adding device. While gas in the glass reaction vessel was replaced with nitrogen, the materials thus introduced were stirred at 60° C. Next, 0.004 parts by weight of EDTA, 0.001 parts by weight of ferrous sulfate heptahydrate, and 0.11 parts by weight of SFS were added to the glass reaction vessel, and a resulting mixture was stirred for 10 minutes. After that, 2.0 parts by weight of triallyl isocyanurate and 0.5 parts by weight of cumene hydroperoxide (QHP) were added to the glass reaction vessel and stirred for 30 minutes. After that, 0.03 parts by weight of the QHP was added to the glass reaction vessel, and a resulting mixture was stirred for another 60 minutes. By such an operation, an aqueous latex (R-2) containing an elastic body containing a crosslinked organosiloxane-based rubber as a main component was obtained.

Subsequently, a mixture of 14.25 parts by weight of methyl methacrylate (MMA), 0.75 parts by weight of butyl acrylate (BA), and 0.04 parts by weight of t-butyl hydroperoxide (BHP) was continuously added over 30 minutes to the glass reaction vessel, after the production of the aqueous latex (R-2), containing the obtained aqueous latex (R-2). After that, 0.013 parts by weight of the BHP was added to the glass reaction vessel, and a resulting mixture in the glass reaction vessel was stirred for another hour so as to finish polymerization. Through the above operations was obtained an aqueous latex (L-1) containing the fine polymer particles (A). 99% or more of the monomer component had been polymerized. The volume-average particle size of the fine polymer particles (A) contained in the obtained aqueous latex was 290 nm.

### Production Example 1-2; Preparation of Aqueous Latex (L-2) Containing Fine Polymer Particles (A)

An aqueous latex (L-2) containing the fine polymer particles (A) was obtained by the same method as in Production Example 1-1 except that a mixture of 13.5 parts by weight of MMA, 0.75 parts by weight of BA, 0.75 parts by weight of glycidyl methacrylate (GMA), and 0.04 parts by weight of t-butyl hydroperoxide (BHP) was used instead of the mixture of 14.25 parts by weight of MMA, 0.75 parts by weight of BA, and 0.04 parts by weight of t-butyl hydroperoxide (BHP) in Production Example 1-1. 99% or more of the monomer component had been polymerized. The volume-average particle size of the fine polymer particles (A) contained in the obtained aqueous latex was 292 nm.

### Production Example 1-3; Preparation of Aqueous Latex (L-3) Containing Fine Polymer Particles (A)

An aqueous latex (L-3) containing the fine polymer particles (A) was obtained by the same method as in Production Example 1-1 except that a mixture of 12.75 parts by weight of MMA, 0.75 parts by weight of BA, 1.5 parts by weight of GMA, and 0.04 parts by weight of t-butyl hydroperoxide (BHP) was used instead of the mixture of 14.25 parts by weight of MMA, 0.75 parts by weight of BA, and 0.04 parts by weight of t-butyl hydroperoxide (BHP) in Production Example 1-1. 99% or more of the monomer component had been polymerized. The volume-average particle size of the fine polymer particles (A) contained in the obtained aqueous latex was 290 nm.

### Production Example 1-4; Preparation of Aqueous Latex (L-4) Containing Fine Polymer Particles (A)

An aqueous latex (L-4) containing the fine polymer particles (A) was obtained by the same method as in Production Example 1-1 except that a mixture of 10.75 parts by weight of MMA, 0.75 parts by weight of BA, 3.5 parts by weight of GMA, and 0.04 parts by weight of t-butyl hydroperoxide (BHP) was used instead of the mixture of 14.25 parts by weight of MMA, 0.75 parts by weight of BA, and 0.04 parts by weight of t-butyl hydroperoxide (BHP) in Production Example 1-1. 99% or more of the monomer component had been polymerized. The volume-average particle size of the fine polymer particles (A) contained in the obtained aqueous latex was 291 nm.

### Production Example 1-5; Preparation of Aqueous Latex (L-5) Containing Fine Polymer Particles (A)

An aqueous latex (L-5) containing the fine polymer particles (A) was obtained by the same method as in Production Example 1-1 except that a mixture of 9.75 parts by weight of MMA, 0.75 parts by weight of BA, 4.5 parts by weight of GMA, and 0.04 parts by weight of t-butyl hydroperoxide (BHP) was used instead of the mixture of 14.25 parts by weight of MMA, 0.75 parts by weight of BA, and 0.04 parts by weight of t-butyl hydroperoxide (BHP) in Production Example 1-1. 99% or more of the monomer component had been polymerized. The volume-average particle size of the fine polymer particles (A) contained in the obtained aqueous latex was 292 nm.

### Production Example 1-6; Preparation of Aqueous Latex (L-6) Containing Fine Polymer Particles (A)

Into a pressure-resistant polymerization apparatus were introduced 200 parts by weight of deionized water, 0.03 parts by weight of tripotassium phosphate, 0.002 parts by weight of disodium ethylenediaminetetraacetate (EDTA), 0.001 parts by weight of ferrous sulfate heptahydrate, and 1.55 parts by weight of sodium dodecylbenzenesulfonate (SDBS). Next, while the materials thus introduced were stirred, gas in the pressure-resistant polymerization apparatus was replaced with nitrogen, so as to sufficiently remove oxygen from the inside of the pressure-resistant polymerization apparatus. After that, 100 parts by weight of butadiene (Bd) was introduced into the pressure-resistant polymerization apparatus, and the temperature inside the pressure-resistant polymerization apparatus was raised to 45° C. After that, 0.03 parts by weight of paramenthane hydroperoxide (PHP) was introduced into the pressure-resistant polymerization apparatus, and then 0.10 parts by weight of sodium formaldehyde sulfoxylate (SFS) was introduced into the pressure-resistant polymerization apparatus. Polymerization was then started. At the time 15 hours had elapsed from the start of the polymerization, residual monomers not used in the polymerization were removed by devolatilization under reduced pressure, and thereby the polymerization was ended. During the polymerization, PHP, EDTA, and ferrous sulfate heptahydrate were each added to the pressure-resistant polymerization apparatus in discretionarily selected amounts and discretionarily selected points in time. By the polymerization, an aqueous latex (R-2), which contained an elastic body (core layer) containing polybutadiene rubber as a main component, was obtained. The volume-average particle size of the elastic body (core layer) contained in the obtained aqueous latex was 90 nm.

Into a pressure-resistant polymerization apparatus were introduced 7 parts by weight (in terms of solid content) of the polybutadiene rubber latex (R-2) obtained above, 200 parts by weight of deionized water, 0.03 parts by weight of tripotassium phosphate, 0.002 parts by weight of EDTA, and 0.001 parts by weight of ferrous sulfate heptahydrate. Next, while the materials thus introduced were stirred, gas in the pressure-resistant polymerization apparatus was replaced with nitrogen, so as to sufficiently remove oxygen from the inside of the pressure-resistant polymerization apparatus. After that, 93 parts by weight of Bd was introduced into the pressure-resistant polymerization apparatus, and the temperature inside the pressure-resistant polymerization apparatus was raised to 45° C. After that, 0.02 parts by weight of PHP was introduced into the pressure-resistant polymerization apparatus, and then 0.10 parts by weight of SFS was introduced into the pressure-resistant polymerization apparatus. Polymerization was then started. At the time 30 hours had elapsed from the start of the polymerization, residual monomers not used in the polymerization were removed by devolatilization under reduced pressure, and thereby the polymerization was ended. During the polymerization, PHP, EDTA, and ferrous sulfate heptahydrate were each added to the pressure-resistant polymerization apparatus in discretionarily selected amounts and discretionarily selected points in time. By the polymerization, an aqueous latex (R-3), which contained an elastic body (core layer) containing polybutadiene rubber as a main component, was obtained. The volume-average particle size of the elastic body (core layer) contained in the obtained aqueous latex was 195 nm.

Into a glass reaction vessel were introduced 260 parts by weight of the polybutadiene rubber latex (R-3) (including 85 parts by weight of the elastic body containing polybutadiene rubber as a main component) and 50 parts by weight of deionized water. The glass reaction vessel here had a thermometer, a stirrer, a reflux condenser, a nitrogen inlet, and a monomer addition device. While gas in the glass reaction vessel was replaced with nitrogen, the materials thus introduced were stirred at 60° C. Next, 1.8 parts by weight of 1,3-butylene glycol dimethacrylate and 0.07 parts by weight of t-butyl hydroperoxide (BHP) were added to the glass reaction vessel, and a resulting mixture was stirred for 10 minutes. After that, 0.004 parts by weight of EDTA, 0.001 parts by weight of ferrous sulfate heptahydrate, and 0.13 parts by weight of SFS were added to the glass reaction vessel, and a resulting mixture was stirred for 30 minutes. After that, 0.013 parts by weight of the BHP was added to the glass reaction vessel, and a resulting mixture was stirred for another 30 minutes. After that, a mixture of 14.25 parts by weight of MMA, 0.75 parts by weight of BA, and 0.05 parts by weight of BHP was continuously added to the glass reaction vessel over 60 minutes. After that, 0.013 parts by weight of the BHP was added to the glass reaction vessel, and a resulting mixture in the glass reaction vessel was stirred for another hour so as to finish polymerization. Through the above operations was obtained an aqueous latex (L-6) containing the fine polymer particles (A). 99% or more of the monomer component had been polymerized. The volume-average particle size of the fine polymer particles (A) contained in the obtained aqueous latex was 200 nm.

### Production Example 1-7; Preparation of Aqueous Latex (L-7) Containing Fine Polymer Particles (A)

An aqueous latex (L-7) containing the fine polymer particles (A) was obtained by the same method as in Production Example 1-6 except that a mixture of 12.75 parts by weight of MMA, 0.75 parts by weight of BA, 1.5 parts by weight of GMA, and 0.05 parts by weight of BHP was used instead of the mixture of 14.25 parts by weight of MMA, 0.75 parts by weight of BA, and 0.05 parts by weight of BHP in Production Example 1-6. 99% or more of the monomer component had been polymerized. The volume-average particle size of the fine polymer particles (A) contained in the obtained aqueous latex was 200 nm.

### Production Example 1-8; Preparation of Aqueous Latex (L-8) Containing Fine Polymer Particles (A)

An aqueous latex (L-8) containing the fine polymer particles (A) was obtained by the same method as in Production Example 1-6 except that a mixture of 9.75 parts by weight of MMA, 0.75 parts by weight of BA, 4.5 parts by weight of GMA, and 0.05 parts by weight of BHP was used instead of the mixture of 14.25 parts by weight of MMA, 0.75 parts by weight of BA, and 0.05 parts by weight of BHP in Production Example 1-6. 99% or more of the monomer component had been polymerized. The volume-average particle size of the fine polymer particles (A) contained in the obtained aqueous latex was 200 nm.

<2. Preparation of Powdery and/or Granular Material>

### Example 1; Preparation of Powdery and/or Granular Material (P-2)

Water, 100 parts by weight of epoxidized soybean oil which is the resin (B), and SDBS which is an emulsifying agent were mixed together with use of a homogenizer to prepare an aqueous emulsion (S-1) (the amount of resin (B) contained is 50%) in which the resin (B) had been emulsified. Furthermore, 600 parts by weight of ion exchanged water having 4 parts by weight of calcium acetate dissolved therein and having its temperature controlled to 70° C. was prepared. Next, 250 parts by weight of the aqueous latex (L-2) (equivalent to 100 parts by weight of the fine polymer particles (A)) and 22.2 parts by weight of the aqueous emulsion (S-1) (equivalent to 11.1 parts by weight of the resin (B)) were introduced into 600 parts by weight of the ion exchanged water, and a slurry containing a flocculate containing the fine polymer particles (A) and the resin (B) was obtained. Next, the slurry was subjected to centrifugal dehydration to obtain wet powder, which is the above-mentioned flocculate. Two cycles of the operation of introducing the obtained wet powder into 500 parts of ion exchanged water and the operation of subjecting the obtained mixture to centrifugal dehydration were carried out in total to obtain wet powder. Lastly, the wet powder was dried in a dryer at 50° C. for 48 hours. In this way, a powdery and/or granular material (P-2) was obtained. The dispersibility of the obtained powdery and/or granular material in the matrix resin was measured by the method in the section under (Dispersibility of powdery and/or granular material in matrix resin) described above. The results are shown in Table 1.

A resin composition was prepared with use of the powdery and/or granular material (P-2) by the method in the section under (Measurement of physical properties of cured product of epoxy-silica formulation) described above. Further, a cured product was prepared with use of such a resin composition by the method in the section under (Measurement of physical properties of cured product of epoxy-silica formulation) described above. For the obtained cured product, the elastic modulus and the linear expansion coefficient were measured by the above-described method. The results are shown in Table 1.

### Example 2; Preparation of Powdery and/or Granular Material (P-3)

A powdery and/or granular material (P-3) was obtained in the same method as in Example 1 except that the aqueous latex (L-3) was used instead of the aqueous latex (L-2) in Example 1. The dispersibility of the obtained powdery and/or granular material in the matrix resin was measured by the method in the section under (Dispersibility of powdery and/or granular material in matrix resin) described above. The results are shown in Table 1.

A resin composition was prepared with use of the powdery and/or granular material (P-3) by the method in the section under (Measurement of physical properties of cured product of epoxy-silica formulation) described above. Further, a cured product was prepared with use of such a resin composition by the method in the section under (Measurement of physical properties of cured product of epoxy-silica formulation) described above. For the obtained cured product, the elastic modulus and the linear expansion coefficient were measured by the above-described method. The results are shown in Table 1.

### Example 3; Preparation of Powdery and/or Granular Material (P-4)

A powdery and/or granular material (P-4) was obtained in the same method as in Example 1 except that the aqueous latex (L-4) was used instead of the aqueous latex (L-2) in Production Example 2-1. The dispersibility of the obtained powdery and/or granular material in the matrix resin was measured by the method in the section under (Dispersibility of powdery and/or granular material in matrix resin) described above. The results are shown in Table 1.

A resin composition was prepared with use of the powdery and/or granular material (P-4) by the method in the section under (Measurement of physical properties of cured product of epoxy-silica formulation) described above. Further, a cured product was prepared with use of such a resin composition by the method in the section under (Measurement of physical properties of cured product of epoxy-silica formulation) described above. For the obtained cured product, the elastic modulus and the linear expansion coefficient were measured by the above-described method. The results are shown in Table 1.

### Comparative Example 1; Preparation of Powdery and/or Granular Material (P-1)

A powdery and/or granular material (P-1) was obtained in the same method as in Example 1 except that the aqueous latex (L-1) was used instead of the aqueous latex (L-2) in Example 1. The dispersibility of the obtained powdery and/or granular material in the matrix resin was measured by the method in the section under (Dispersibility of powdery and/or granular material in matrix resin) described above. The results are shown in Table 1.

A resin composition was prepared with use of the powdery and/or granular material (P-1) by the method in the section under (Measurement of physical properties of cured product of epoxy-silica formulation) described above. Further, a cured product was prepared with use of such a resin composition by the method in the section under (Measurement of physical properties of cured product of epoxy-silica formulation) described above. For the obtained cured product, the elastic modulus and the linear expansion coefficient were measured by the above-described method. The results are shown in Table 1.

### Comparative Example 2; Preparation of Powdery and/or Granular Material (P-5)

A powdery and/or granular material (P-5) was obtained in the same method as in Example 1 except that the aqueous latex (L-5) was used instead of the aqueous latex (L-2) in Example 1. The dispersibility of the obtained powdery and/or granular material in the matrix resin was measured by the method in the section under (Dispersibility of powdery and/or granular material in matrix resin) described above. The results are shown in Table 1.

A resin composition was prepared with use of the powdery and/or granular material (P-5) by the method in the section under (Measurement of physical properties of cured product of epoxy-silica formulation) described above. Further, a cured product was prepared with use of such a resin composition by the method in the section under (Measurement of physical properties of cured product of epoxy-silica formulation) described above. For the obtained cured product, the elastic modulus and the linear expansion coefficient were measured by the above-described method. The results are shown in Table 1.

### (Comparative Example 3; Preparation of Powdery and/or Granular Material (P-6)

(i) Water, (ii) a mixture, which is the resin (B), of 90 parts by weight of epoxidized soybean oil and 10 parts by weight of triethylene glycol bis[3-(−t-butyl-4-hydroxy-5-methylphenyl)propionate], and (iii) SDBS which is an emulsifying agent were mixed together with use of a homogenizer to prepare an aqueous emulsion (S-2) (the amount of resin (B) contained is 11.1%) in which the resin (B) had been emulsified. A powdery and/or granular material (P-6) was obtained in the same method as in Example 1 except that 22.2 parts by weight of the aqueous emulsion (S-2) was used instead of 22.2 parts by weight of the aqueous emulsion (S-1) in Example 1, and the aqueous latex (L-6) was used instead of the aqueous latex (L-2) in Example 1. The dispersibility of the obtained powdery and/or granular material in the matrix resin was measured by the method in the section under (Dispersibility of powdery and/or granular material in matrix resin) described above. The results are shown in Table 1.

A resin composition was prepared with use of the powdery and/or granular material (P-6) by the method in the section under (Measurement of physical properties of cured product of epoxy-silica formulation) described above. Further, a cured product was prepared with use of such a resin composition by the method in the section under (Measurement of physical properties of cured product of epoxy-silica formulation) described above. For the obtained cured product, the elastic modulus and the linear expansion coefficient were measured by the above-described method. The results are shown in Table 1.

### Comparative Example 4; Preparation of Powdery and/or Granular Material (P-7)

A powdery and/or granular material (P-7) was obtained in the same method as in Comparative Example 3 except that the aqueous latex (L-7) was used instead of the aqueous latex (L-6) in Comparative Example 3. The dispersibility of the obtained powdery and/or granular material in the matrix resin was measured by the method in the section under (Dispersibility of powdery and/or granular material in matrix resin) described above. The results are shown in Table 1.

A resin composition was prepared with use of the powdery and/or granular material (P-7) by the method in the section under (Measurement of physical properties of cured product of epoxy-silica formulation) described above. Further, a cured product was prepared with use of such a resin composition by the method in the section under (Measurement of physical properties of cured product of epoxy-silica formulation) described above. For the obtained cured product, the elastic modulus and the linear expansion coefficient were measured by the above-described method. The results are shown in Table 1.

### Comparative Example 5; Preparation of Powdery and/or Granular Material (P-8)

A powdery and/or granular material (P-8) was obtained in the same method as in Comparative Example 3 except that the aqueous latex (L-8) was used instead of the aqueous latex (L-6) in Comparative Example 3. The dispersibility of the obtained powdery and/or granular material in the matrix resin was measured by the method in the section under (Dispersibility of powdery and/or granular material in matrix resin) described above. The results are shown in Table 1.

A resin composition was prepared with use of the powdery and/or granular material (P-8) by the method in the section under (Measurement of physical properties of cured product of epoxy-silica formulation) described above. Further, a cured product was prepared with use of such a resin composition by the method in the section under (Measurement of physical properties of cured product of epoxy-silica formulation) described above. For the obtained cured product, the elastic modulus and the linear expansion coefficient were measured by the above-described method. The results are shown in Table 1.

### Comparative Example 6

In Comparative Example 6, no stress reducing agent (powdery and/or granular material) was used. A resin composition was prepared by a method which is the same as the method in the section under (Measurement of physical properties of cured product of epoxy-silica formulation) described above, except that no powdery and/or granular material was used, that is, except that 33.3 parts by weight of Bisphenol A epoxy resin was used instead of 33.3 parts by weight of the resin composition containing the powdery and/or granular material. Further, a cured product was prepared with use of such a resin composition by the method in the section under (Measurement of physical properties of cured product of epoxy-silica formulation) described above. For the obtained cured product, the elastic modulus and the linear expansion coefficient were measured by the above-described method. The results are shown in Table 1.

### [Table 1]

TABLE 1

| | | Exam- | Exam- | Exam- | Comparative | Comparative |
|---|---|---|---|---|---|---|
| | | ple 1 | ple 2 | ple 3 | Example 1 | Example 2 |
| Elastic body | Polybutadiene rubber | — | — | — | — | — |
| | Organosiloxane-based rubber | 85 | 85 | 85 | 85 | 85 |
| Graft part | MMA | 13.5 | 12.75 | 10.75 | 14.25 | 9.75 |
| | BA | 0.75 | 0.75 | 0.75 | 0.75 | 0.75 |
| | GMA | 0.75 | 1.5 | 3.5 | — | 4.5 |
| Dipersion time (min) | | 30 | 30 | 50 | 40 | >60 |
| Physical property | Elastic modulus (Gpa) | 3.82 | 3.85 | 3.87 | 3.81 | 3.87 |
| evaluation | Linear expansion coefficient (×10⁻⁵° C.) | 6.01 | 5.80 | 5.83 | 6.15 | 5.84 |

| | | Comparative | Comparative | Comparative | Comparative |
|---|---|---|---|---|---|
| | | Example 3 | Example 4 | Example 5 | Example 6 |
| Elastic body | Polybutadiene rubber | 85 | 85 | 85 | — |
| | Organosiloxane-based rubber | — | — | — | — |
| Graft part | MMA | 14.25 | 12.75 | 9.75 | — |
| | BA | 0.75 | 0.75 | 0.75 | — |
| | GMA | — | 1.5 | — | — |
| Dipersion time (min) | | 20 | 20 | 20 | — |
| Physical property | Elastic modulus (Gpa) | 3.85 | 3.91 | 3.9 | 4.34 |
| evaluation | Linear expansion coefficient (×10⁻⁵° C.) | 6.30 | 6.28 | 6.27 | 5.64 |

### [Results]

The following is found from Table 1.

(1) It is found that, in a case where stress reducing agents are produced with use of the fine polymer particles (A) in Examples 1 to 3 each having a rubber-containing graft copolymer that includes an elastic body containing an organosiloxane-based rubber and a graft part grafted to the elastic body, resulting cured products have a comparably low elastic modulus and a significantly small linear expansion coefficient, that is, a favorable linear expansion coefficient, in comparison to Comparative Examples 3 to 5 using the fine polymer particles in which the elastic body contains no organosiloxane-based rubber.

(2) It is found that, in a case where stress reducing agents are produced with use of the fine polymer particles that are the fine polymer particles (A) in Examples 1 to 3 in which the graft part contains an epoxy group-containing structural unit, resulting cured products have a low elastic modulus and a more favorable linear expansion coefficient, in comparison to Comparative Example 1 using the fine polymer particles in which the graft part contains no epoxy group-containing structural unit.

(3) It is found that the fine polymer particles (A) in Examples 1 to 3 in which the epoxy group-containing structural unit in the graft part is contained in an amount of not more than 4.0% by weight with respect to the rubber-containing graft copolymer are excellent in dispersibility in a matrix resin before curing, in comparison to the fine polymer particles in Comparative Example 2 in which the epoxy group-containing structural unit in the graft part is contained in an amount of 4.5% by weight.

One or more embodiments of the present invention make it possible to provide a stress reducing agent (i) that is excellent in dispersibility in a matrix resin and (ii) that enables provision of a cured product which has a favorable linear expansion coefficient. Therefore, a resin composition containing a stress reducing agent in accordance with one or more embodiments of the present invention is suitably used as a sealing material in electronic materials and the like.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A stress reducing agent comprising fine polymer particles (A), wherein:
the fine polymer particles (A) contain a rubber-containing graft copolymer that includes an elastic body and a graft part grafted to the elastic body;
a proportion of the elastic body contained in the fine polymer particles (A) is more than 70% by weight and not more than 97% by weight, with respect to 100% by weight of the fine polymer particles (A);
the elastic body contains an organosiloxane-based rubber;
the graft part contains an epoxy group-containing structural unit;
the epoxy group-containing structural unit in the graft part is contained in an amount of not less than 0.5% by weight and less than 3.2% by weight with respect to 100% by weight of the rubber-containing graft copolymer; and
the stress reducing agent is a powdery and/or granular material.

2. The stress reducing agent according to claim 1, wherein the epoxy group-containing structural unit in the graft part is contained in an amount of 3.3% by weight to 26.7% by weight with respect to 100% by weight of the graft part in the rubber-containing graft copolymer.

3. A stress reducing agent comprising fine polymer particles (A), wherein:
the fine polymer particles (A) contain a rubber-containing graft copolymer that includes an elastic body and a graft part grafted to the elastic body;
a proportion of the elastic body contained in the fine polymer particles (A) is not less than 85% by weight and not more than 97% by weight, with respect to 100% by weight of the fine polymer particles (A);
the elastic body contains an organosiloxane-based rubber;
the graft part contains an epoxy group-containing structural unit;
the epoxy group-containing structural unit in the graft part is contained in an amount of 3.3% by weight to 26.7% by weight with respect to 100% by weight of the graft part in the rubber-containing graft copolymer; and
the stress reducing agent is a powdery and/or granular material.

4. The stress reducing agent according to claim 1, wherein the epoxy group-containing structural unit in the graft part is a glycidyl methacrylate unit.

5. The stress reducing agent according to claim 1, further comprising a resin (B).

6. A resin composition comprising:
the stress reducing agent according to claim 1;
a thermosetting resin; and
an inorganic filler.

7. The resin composition according to claim 6, wherein the thermosetting resin is an epoxy-based resin, and the inorganic filler is silica.

8. A sealing material comprising the resin composition according to claim 6.

9. A sealing material comprising the resin composition according to claim 7.

10. A method for producing a resin composition, comprising a step of mixing a stress reducing agent containing fine polymer particles (A), a thermosetting resin, and an inorganic filler, wherein:
the fine polymer particles (A) contain a rubber-containing graft copolymer that includes an elastic body and a graft part grafted to the elastic body;
a proportion of the elastic body contained in the fine polymer particles (A) is more than 70% by weight and not more than 97% by weight, with respect to 100% by weight of the fine polymer particles (A);
the elastic body contains an organosiloxane-based rubber;
the graft part contains an epoxy group-containing structural unit;
the epoxy group-containing structural unit in the graft part is contained in an amount not less than 0.5% by weight and less than 3.2% by weight with respect to 100% by weight of the rubber-containing graft copolymer; and
the stress reducing agent is a powdery and/or granular material.

11. The method according to claim 10, wherein the epoxy group-containing structural unit in the graft part is contained in an amount of 3.3% by weight to 26.7% by weight with respect to 100% by weight of the graft part in the rubber-containing graft copolymer.

12. A method for producing a resin composition, comprising a step of mixing a stress reducing agent containing fine polymer particles (A), a thermosetting resin, and an inorganic filler, wherein:
the fine polymer particles (A) contain a rubber-containing graft copolymer that includes an elastic body and a graft part grafted to the elastic body;
a proportion of the elastic body contained in the fine polymer particles (A) is not less than 85% by weight and not more than 97% by weight, with respect to 100% by weight of the fine polymer particles (A);
the elastic body contains an organosiloxane-based rubber;
the graft part contains an epoxy group-containing structural unit;
the epoxy group-containing structural unit in the graft part is contained in an amount of 3.3% by weight to 26.7% by weight with respect to 100% by weight of the graft part in the rubber-containing graft copolymer; and
the stress reducing agent is a powdery and/or granular material.

13. The method according to claim 10, wherein the epoxy group-containing structural unit in the graft part is a glycidyl methacrylate unit.

14. The method according to claim 10, wherein the stress reducing agent further comprises a resin (B).

15. The method according to claim 10, wherein the thermosetting resin is an epoxy-based resin, and the inorganic filler is silica.

16. The stress reducing agent according to claim 3, wherein the epoxy group-containing structural unit in the graft part is a glycidyl methacrylate unit.

17. The stress reducing agent according to claim 3, further comprising a resin (B).

18. A resin composition comprising:
the stress reducing agent according to claim 3;
a thermosetting resin; and
an inorganic filler.

19. The resin composition according to claim 18, wherein the thermosetting resin is an epoxy-based resin, and the inorganic filler is silica.

20. A sealing material comprising the resin composition according to claim 18.
